(19) United States
(12) Patent Application Publication
(10) Pub. No.: US 2017/0174795 A1
(43) Pub. Date: Jun. 22, 2017

(54) ULTRAPURE COPOLYMERS

(71) Applicant: ARLANXEO SINGAPORE PTE. LTD., Singapore (SG)

(72) Inventors: Conrad SIEGERS, Edmonton (CA); David THOMPSON, London (CA)

(73) Assignee: ARLANXEO Singapore Pte. Ltd., Singapore (SG)

(21) Appl. No.: 15/327,460

(22) PCT Filed: Jul. 21, 2015
(86) PCT No.: PCT/CA2015/050675

§ 371 Date: Jan. 19, 2017

(30) Foreign Application Priority Data
Jul. 24, 2014 (EP) 14178258.1

(51) Int. Cl. C08F 6/04; C08K 5/098; C08L 9/00; C08L 15/02; C08F 8/20; C08F 210/12

(52) U.S. Cl. CPC C08F 6/04; C08F 8/20; C08F 210/12; C08L 9/00; C08L 15/02; C08K 5/098; C08L 2205/025

(57) ABSTRACT

The invention relates to a method to reduce or prevent agglomeration of particles of optionally halogenated rubbers in aqueous media by LCST compounds, their purification as well as ultrapure optionally halogenated rubbers. The invention further relates to (halogenated) copolymer products comprising the same or derived therefrom.

### FIELD OF THE INVENTION

The invention relates to a method to reduce or prevent agglomeration of particles of optionally halogenated rubbers in aqueous media by LCST compounds, their purification as well as ultrapure optionally halogenated rubbers. The invention further relates to (halogenated) copolymer products comprising the same or derived therefrom.

### BACKGROUND

Butyl rubbers in particular those comprising repeating units derived from isoolefins are industrially prepared by carbocationic polymerization processes. Of particular importance are isobutylene-isoprene rubbers (IIR) and their halogenated derivatives chlorobutyl rubber (CIIR) and bromobutyl rubber (BIIR).

In the conventional process for producing butyl rubber e.g. isobutene and isoprene are polymerized in a polar halohydrocarbon medium, such as methyl chloride with an aluminum based initiating system, typically either aluminum trichloride (AlCl₃) or ethyl aluminum dichloride (EtAlCl₂). The butyl rubber does not appreciably dissolve in this polar medium, but is present as suspended particles and so this process is normally referred to as a slurry process. Residual monomers and polymerization medium are typically removed via distillation or stripping and the resulting polymer then isolated or further modified, in particular by halogenation.

In other polymerization processes hydrocarbons are employed and the resulting polymer solution is either worked up according to known procedures or the cement (a solution of butyl rubber in a hydrocarbon) after removal of monomers is directly employed in a halogenation process.

After halogenation of butyl rubber the reaction mixture typically comprises the butyl halogenated rubber and the diluent. This mixture which is typically a solution is after neutralization and phase separation typically either batchwise or more commonly in industry continually transferred into a steam-stripper wherein the aquous phase comprises an anti-agglomerant which for all existing commercial grades today is a fatty acid salt of a multivalent metal ion, in particular either calcium stearate or zinc stearate in order to form and preserve halogenated butyl rubber particles, which are more often referred to as “halobutyl rubber crumb”

The water in this vessel is typically steam heated to remove and recover the diluent.

As a result thereof a slurry of halogenated butyl rubber particles is obtained which is then subjected to dewatering to isolate halogenated butyl rubber particles. The isolated halogenated butyl rubber particles are then dried, baled and packed for delivery.

The anti-agglomerant ensures that in the process steps described above the halogenated butyl rubber particles stay suspended and show a reduced tendency to agglomerate.

In the absence of an anti-agglomerant the naturally high adhesion of halogenated butyl rubber would lead to rapid formation of a non-dispersed mass of rubber in the process water, plugging the process. In addition to particle formation, sufficient anti-agglomerant must be added to delay the natural tendancy of the formed halogenated butyl rubber particles to agglomerate during the stripping process, which leads to fouling and plugging of the process.

The anti-agglomerants in particular calcium and zinc stearates function as a physical-mechanical barrier to limit the close contact and adhesion of butyl rubber particles.

The physical properties required of these anti-agglomerants are a very low solubility in water which is typically below 20 mg per liter under standard conditions, sufficient mechanical stability to maintain an effective barrier, and the ability to be later processed and mixed with the butyl rubber to allow finishing and drying.

One disadvantage of fatty acid salts of a mono- or multivalent metal ion, in particular sodium, potassium calcium or zinc stearate or palmitate is that they contribute to high levels of extractable matter which is undesired in particular where cure or uncured butyl rubber products come into contact with food, pharmaceuticals or human tissue or blood.

In addition to that butyl rubber production produces small amounts of cyclic polymers as side products. Such cyclic polymers may also be undesirable in such applications of butyl rubber. Therefore a reduction in cyclic polymer levels in the butyl rubber or halogenated butyl rubbers may be desirable. Furthermore, such cyclic polymers may themselves find utility in certain applications such as precursors for the production of lubricants and traction fluids, therefore obtaining the cyclic polymers themselves may also be desirable.

It is known from U.S. Pat. No. 7,071,292 and European Patent Publication EP 2610296 that solutions of nitrile rubber and other elastomers in an organic solvent may be purified by ultrafiltration methods. Impurities removed by these processes include emulsifiers, organic and/or inorganic salts or acids such as fatty acids and resins, water, unreacted initiator residues and/or decomposition products, stabilizers, molecular weight regulators, monomers, processing agents, such as flocculants, oligomeric components with a molecular weight of less than 2000 g/mol and transition metal catalysts for the hydrogenation or metathesis, oxidizing and/or reducing agents and/or components of these transition metal catalysts, oxidizing and/or reducing agents preferred impurities are fatty acids, fatty acid esters and Na, K, Ca salts of fatty acids, or resin acids, stabilizers, flocculants water, catalyst components, and ligands. Removing Ca salts of fatty acids however would result in diminished capability to process butyl rubber or halogenated butyl rubber as described above.

Therefore, there still remains a need for a method for the preparation of (halogenated) rubber particles in aqueous media still having a reduced or low tendency of agglomeration but with low levels of cyclic copolymers.

### SUMMARY OF THE INVENTION

According to one aspect of the invention, there is provided a process for the preparation of a pure (halogenated) copolymer comprising at least the steps of:

A) filtering a first organic medium comprising:
i) at least one (halogenated) copolymer comprising a fraction of cyclic copolymers having a molecular weight of 2000 g/mol or less and
ii) an organic diluent
through a semipermeable ultrafiltration membrane to produce
a retentate comprising at least one (halogenated) copolymer comprising a fraction of cyclic copolymers having a molecular weight of 2000 g/mol or less which is lower than in the (halogenated) copolymer employed in the organic medium before filtration and an organic diluent
a permeate comprising cyclic copolymers having a molecular weight of 2000 g/mol or less and an organic diluent.
   B) contacting a second organic medium comprising
i) the (halogenated) copolymer of or obtainable from the retentate and
ii) an organic diluent
with an aqueous medium comprising at least one LCST compound having a cloud point of 0 to 100° C., preferably 5 to 100° C., more preferably 15 to 80° C. and even more preferably 20 to 70° C. and removing at least partially the organic diluent to obtain the pure (halogenated) copolymer.

### DETAILED DESCRIPTION OF THE INVENTION

As used herein, the term copolymer encompasses any product which contain at least 2 repeating units of the monomers employed. This includes including cyclic compounds.

The term halogenated copolymer denotes copolymers which were halogenated and thus comprise halogen atoms bound in the copolymer. The term (halogenated) copolymer denotes copymers and halogenated copolymers as defined hereinabove.

The invention also encompasses all combinations of preferred embodiments, ranges parameters as disclosed hereinafter with either each other or the broadest disclosed range or parameter.

In step A) a first organic medium comprising at least one (halogenated) copolymer comprising a fraction of cyclic copolymers having a molecular weight of 2000 g/mol or less and an organic diluent is filtered through a semipermeable ultrafiltration membrane.

Preferred (halogenated) copolymers include (halogenated) copolymers comprising repeating units derived from at least one isoolefin and at least one multiolefin whereby for halogenated copolymers the repeating units derived from the at least one multiolefin are at least partially halogenated.

Examples of suitable isoolefins include isoolefin monomers having from 4 to 16 carbon atoms, preferably 4 to 7 carbon atoms, such as isobutene, 2-methyl-1-butene, 3-methyl-1-butene, 2-methyl-2-butene. A preferred isolefin is isobutene.

Examples of suitable multiolefins include isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 4-butyl-1,3-pentadiene, 2,3-dimethyl-1,3-pentadiene, 2,3-dibutyl-1,3-pentadiene, 2-ethyl-1,3-pentadiene, 2-ethyl-1,3-butadiene, 2-methyl-1,6-heptadiene, cyclopentadiene, methylcyclopentadiene, cyclohexadiene and 1-vinyl-cyclohexadiene.

Preferred multiolefins are isoprene and butadiene. Isoprene is particularly preferred.

The (halogenated) copolymers may or may not further comprise repeating units derived from further olefins which are neither isoolefins nor multiolefins.

Examples of such suitable olefins include the β-pinene, styrene, divinylbenzene, diisopropenylbenzene, o-, m- and p-methyl-styrene.

The multiolefin content of the (halogenated) copolymers is typically 0.1 mol-% or more, preferably of from 0.1 mol-% to 15 mol-%, in another embodiment 0.5 mol-% or more, preferably of from 0.5 mol-% to 10 mol-%, in another embodiment 0.7 mol-% or more, preferably of from 0.7 to 8.5 mol-% in particular of from 0.8 to 1.5 or from 1.5 to 2.5 mol-% or of from 2.5 to 4.5 mol-% or from 4.5 to 8.5 mol-%, particularly where isobutene and isoprene are employed.

For halogenated coplolymers the halogen level is for example of from 0.1 to 5 wt.-%, preferably of from 0.5 to 3.0 wt.-% with respect to the halogenated copolymer.

The halogenated copolymer may be a brominated copolymer or a chlorinated copolymer.

The term “multiolefin content” denotes the molar amount of repeating units derived from multiolefins with respect to all repeating units of the (halogenated) copolymer.

In one embodiment the weight average molecular weight of the (halogenated) copolymer is in the range of from 10 to 2,000 kg/mol, preferably in the range of from 20 to 1,000 kg/mol, more preferably in the range of from 50 to 1,000 kg/mol, even more preferably in the range of from 200 to 800 kg/mol, yet more preferably in the range of from 375 to 550 kg/mol, and most preferably in the range of from 400 to 500 kg/mol. Molecular weights are obtained using gel permeation chromatography in tetrahydrofuran (THF) solution using polystyrene molecular weight standards if not mentioned otherwise.

In one embodiment the polydispersity of the (halogenated) copolymer is in the range of 1.5 to 4.5 as measured by the ratio of weight average molecular weight to number average molecular weight as determined by gel permeation chromatography.

The (halogenated) copolymer for example and typically has a Mooney viscosity of at least 10 (ML 1+8 at 125° C., ASTM D 1646), preferably of from 10 to 80, more preferably of from 20 to 80 and even more preferably of from 25 to 60 (ML 1+8 at 125° C., ASTM D 1646).

The fraction of cyclic copolymers having a molecular weight of 2000 g/mol or less of the copolymer employed in the first organic medium is for example in the range of from 900 to 5,000 ppm, preferably of from 1,000 to 4,000 ppm and more preferably of from 1,500 to 3,000 ppm of the total weight of the (halogenated) copolymers.

The fraction of cyclic copolymers having a molecular weight of 2000 g/mol or less of the (halogenated) copolymer in the resulting retentate is lower than that of the (halogenated) copolymer in the first organic medium employed for step A) and is for example in the range of from 20 to 2,000, preferably of from 30 to 1,000 ppm, more preferably from 50 to 850 ppm and more preferably of from 50 to 500 ppm of the total weight of the (halogenated) copolymers.

In another embodiment the the fraction of cyclic copolymers having a molecular weight of 2000 g/mol or less of the (halogenated) copolymer in the resulting retentate is 90% or less, preferably 70% or less, more preferably 50% or less and even more preferably 30% or less of the fraction of the (halogenated) copolymer in the first organic medium employed for step A).

Where isobutylene is employed as isoolefin and isoprene as multiolefin the cyclic polymers, typically produced as part of the copolymer include C₁₃ (1-isopropenyl-2,2,4,4-tetramethylcyclohexane, C₁₃H₂₄) and C₂₁ (1,1,5,5-tetramethyl-2-(1-methylethenyl)-3-(2,2,4-trimethylpentyl)-cyclohexane, C₂₁H₄₀) cyclic copolymers having the following structures:

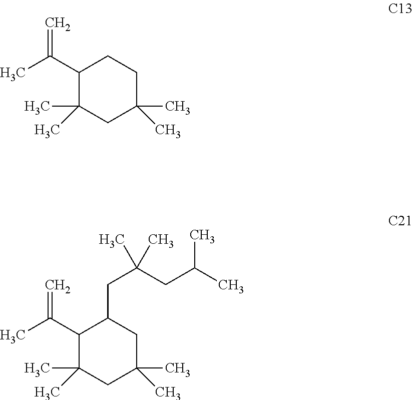

These cyclic oligomers are unsaturated and may form halogenated derivatives upon halogenation of the copolymers.

The term cyclic polymers thus includes halogenated cyclic polymers where halogenated copolymers are mentioned.

Since the aforementioned C13 and C21 copolymers or their halogenated analogues are the predominant cyclic copolymers, in another embodiment of the invention, the term cyclic copolymers having a molecular weight of 2000 g/mol or less exclusively refers to said C13 and C21 copolymers or their halogenated analogues.

The first organic medium further comprises an organic diluent.

The term organic diluent encompasses diluting or dissolving organic chemicals which are liquid under process conditions. Any suitable organic diluent may be used which does not or not to any appreciable extent react with (halogenated) copolymers and provides for a solubility of at least 10 g/l of the copolymer employed.

Additionally, the term organic diluent includes mixtures of at least two diluents.

Examples of suitable orgaic diluents include non-halogenated or halogenated hydrocarbons such as aromatic or aliphatic hydrocarbons and ethers.

Aromatic hydrocarbons include toluene, benzene and chlorobenzene.

Ethers include methyl-tert. butylether, tetrahydrofurane and dioxane.

Preferred examples of organic diluents include aliphatic hydrocarbons which in a further preferred embodiment include neopentane, cyclopentane, n-pentane, isohexane, 2-methylpentane, 3-methylpentane, 2-methylbutane, 2,2-dimethylbutane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethyl pentane, 2-methylheptane, 3-ethylhexane, 2,5-dimethylhexane, 2,2,4,-trimethylpentane, octane, heptane, butane, ethane, methane, nonane, decane, dodecane, undecane, hexane, methyl cyclohexane, methylcyclopentane, 1,1-dimethylcycopentane, cis-1,2-dimethylcyclopentane, trans-1,2-dimethylcyclopentane, trans-1,3-dimethylcyclopentane, ethylcyclopentane, cyclohexane, methylcyclohexane.

Examples of organic diluents further include hydrochlorocarbons, preferably halogenated alkanes such as dichloromethane.

Suitable organic diluents further include mixtures of at least two compounds selected from the groups of hydrochlorocarbons and/or hydrocarbons.

The concentration of the (halogenated) copolymer within the first organic medium is for example of from 0.5 to 40 wt.-%, preferably of from 1 to 30 wt.-%, more preferably of from 5 to 25 wt.-% based on the total weight of the first organic medium.

In one embodiment the concentration is selected such that the (halogenated) copolymer is dissolved to at least 90 wt.-%, preferably to at least 95 wt.-%.

The first organic medium may optionally contain an aqueous phase. The water content may be in a range of about 1 to 40 wt. %, wherein 100 wt. % refers to the total weight of the first organic medium. In one embodiment, the water content is in a range of about 1-40 wt. %, preferably about 2-20 wt. %, more preferably about 3-15 wt %.

Where halogenated copolymers are employed in step A) it is preferred to use the reaction mixture obtained by halogenation of the copolymer as first organic medium optionally after neutralisation with aqueous bases such a aqueous sodium carbonate solutions and/or washing with water.

Consequently, in one embodiment the first organic medium employed in step A) is obtained by a process comprising at least the step of:
i) halogenating an copolymer using a halogenating agent in a organic diluent to obtain an organic medium comprising the halogenated copolymer and the organic diluent and optionally
ii) washing the organic medium comprising the halogenated copolymer with a basic aqueous phase and separating the resulting aqueous phase from the organic medium.

Reference is made to the residual potential water contents which may be included in the first organic medium due to incomplete phase separation.

As used herein “basic” means that the aqueous phase has a pH value of 7.5 to 13, preferably 8 to 12, more preferably 8 to 11 and even more preferably 9 to 10

In step i) the copolymer is halogenated.

Preferably, the amount of halogenating agent is in the range of from about 0.1 to about 20%, preferably in the range of 0.1 to 8%, even more preferably from about 0.5% to about 4%, yet even more preferably from about 0.8% to about 3%, even still more preferably from about 1.5% to about 2.5% and most preferably even more preferably from 1.5 to 2.5% by weight of the copolymer employed.

In another embodiment the quantity of halogenating agent is 0.2 to 1.2 times the molar quantity of double bonds contained in the (halogenated) copolymer in the second organic medium, preferably 0.8 to 1.2 times the molar quantity.

The halogenating agent may comprise elemental bromine (Br₂), elemental chlorine (Cl₂) interhalogens such as bromine chloride (BrCl) and/or organo-halide precursors thereto, for example dibromo-dimethyl hydantoin, N-bromosuccinimide, or the like. The most preferred bromination agent comprises elemental bromine, the most preferred chlorinating agent elemental chlorine.

The halogenation process may be operated at a temperature of from 10° C. to 90° C., preferably from 20° C. to 80° C. and the reaction time may be from 1 to 10 minutes, preferably from 1 to 5 minutes. The pressure in the bromination reactor may be from 0.8 to 10 bar.

The level of halogenation during this procedure may be controlled so that the final halogenated copolymer has the preferred amounts of halogen described hereinabove. The specific mode of attaching the halogen to the polymer is not particularly restricted and those of skill in the art will recognize that modes other than those described above may be used while achieving the benefits of the invention. For additional details and alternative embodiments of solution phase bromination processes, see, for example, Ullmann's Encyclopedia of Industrial Chemistry (Fifth, Completely Revised Edition, Volume A231 Editors Elvers, et al.) and/or “Rubber Technology” (Third Edition) by Maurice Morton, Chapter 10 (Van Nostrand Reinhold Company © 1987), particularly pp. 297-300, which are incorporated herein by reference.

Where (non-halogenated) copolymers are employed in step A) it is possible to use the reaction mixture obtained by carbocationic polymerization in solution, preferably in aliphatic hydrocarbons, preferably after quenching of the initiator and/or removal of unreacted monomers where existent and/or washing with water. Solution polymerizations in aliphatic hydrocarbons are described e.g. in WO2010/006983, WO2011/089091 and WO2011/089092 which are herein incorporated in their entirety.

For the ultrafiltration membrane, it is possible to use any semipermeable and durable size exclusion barrier known in the art of ultrafiltration or nanofiltration. Ultrafiltration membranes which have a highly porous outer layer (support layer) and further more finely porous inner layers (separating layer) are preferred. The highly porous outer layer may be a fabric or nonwoven or a ceramic substructure. The term “highly porous” is intended to mean an average pore diameter of the outer layer in the range of more than about 500 nm. The inner layers are symmetric or asymmetric membranes of suitable polymers applied to the outer layers, or a further more finely porous ceramic layer. The inner layers are more finely porous than their respective outer layer. The pore diameters of the inner layers may also become continuously smaller from the outside inwards. The average pore size of the inner layers, or of at least one inner layer, lies in the range of about 0.5-200 nm, preferably in the range of about 1-50 nm. The exclusion limit of such a membrane being used, which contains outer and inner layers, therefore also lies in the range of about 0.5-200 nm. The membrane may furthermore have a thin range of about 1-50 nm. The membrane may furthermore have a thin separating layer on the surface, which optionally contains ionic groups.

Suitable polymeric membrane materials for both the outer layer and the inner layer of the membrane include polysulfones, polyether sulfones, polyamides, polyimides (also silicone-coated polyimides), polyether ketones, polyureas, polyurethanes, polyvinylidene difluoride, cellulose acetates, cellulose nitrates, polycarbonates, polyacrylonitrile and polyepoxides. Membranes based on oxides, carbonates, carbides and nitrides of the elements aluminum, antimony, barium, beryllium, bismuth, boron, hafnium, cobalt, manganese, magnesium, nickel, silicon, thorium, titanium, tungsten and zirconium, sometimes mixed, are typically used as ceramic components.

Ultrafiltration membranes are generally provided in modules. Any commercially available type of module may be employed. For continuous ultrafiltration methods, suitable membrane modules include, for example, plate modules, coil modules, tube modules, capillary modules and multichannel modules, which may optionally be supported by integrated flow spoilers.

Various ultrafiltration techniques may be employed. In a preferred embodiment, the first organic medium is subjected to crossflow filtration to get high flux. The method may be carried out either batch or continuously. A continuous method is preferred. In a continuous method, membrane modules may be operated in a cascade fashion. The other components may thus be removed stepwise and different concentrations of other components in the first organic medium may be targeted.

Pressures under which the ultrafiltration may be performed may be in a range of about 0.1 to 8.0 MPa, preferably about 0.2 to 5.0 MPa. The permeate contains the other components, and may be replaced by fresh solvent if the intention is to avoid concentrating the first organic medium to be extracted (retentate). An advantage with this method is that the residual concentration of the other components in the pure (halogenated) copolymer can be adjusted in any desired way through the amount of solvent replaced. Preferably, the ultrafiltration is performed at constant volume in which fresh organic diluent is added to the retentate to maintain a constant volume of retentate throughout the ultrafiltration.

Maintaining a high flux in a crossflow filtration technique requires a high crossflow velocity. High concentrations of (halogenated) copolymers in the solution are desirable, but high viscosity resulting from high molecular weight (halogenated) copolymers at high concentration is undesirable. Crossflow filtration at elevated temperature allows processing at high concentration and lower viscosity, thus ultrafiltration at an elevated operating temperature is preferred. The operating temperature is preferably at most about 150° C., more preferably in a range of about 40 to 130° C. An upper limit (increasing concentrations) may be placed on the concentration of (halogenated) copolymers in the solution to be treated by ultrafiltration by the increasing viscosity. This in turn depends on the molecular weight and the monomer composition of the (halogenated) copolymers. In order to reduce the viscosity of the first organic medium, it is advantageous to heat it. The crossflow velocity preferably provides a flow rate of the retentate past the membrane of not less than about 0.5 m/s. Slower flow rates may result in concentration polarization and a drop in permeate flux rate if there are concentrations of (halogenated) copolymers of more than 3 wt. %. A crossflow rate in a range of about 0.5-10 m/s is preferred, more preferably 0.5 to 5 m/s, even more preferably 0.5 to 2 m/s.

Some (halogenated) copolymers require the presence of stabilizers to prevent degradation or other microstructural or molecular weight changes. Further, certain (halogenated) copolymers are particularly sensitive to the presence of hydrogen halide, and unwanted microstructural and/or molecular weight changes in the (halogenated) copolymers can be accelerated at elevated temperatures. For example, although bromination of butyl rubber at moderate temperature (e.g. room temperature, 25° C.) can result in a brominated copolymer with a high proportion of secondary allylic bromine, and minor amounts of tertiary, isomerization to a primary allylic structure increases at elevated temperatures, and isomerization at elevated temperature is also increased in an acidic environment. Therefore, especially when ultrafiltration is performed at elevated temperature, the presence of one or more suitable stabilizers in the retentate is desired.

Thus, it is a particularly advantageous aspect of the present method that ultrafiltration may be performed at elevated temperature in the presence of non-permeating stabilizers, resulting in an efficient ultrafiltration process in which the retentate contains purified (halogenated) copolymer while retaining at least one of the one or more stabilizers, and the permeate is homogeneous and contains other components that were impurities to the (halogenated) copolymers where some of the other components may be products unto themselves (e.g. cyclic copolymers).

The one or more stabilizers are preferably acid scavengers and/or antiagglomerants. For example, in case of the ultrafiltration of (halogenated) copolymers, it is desirable to choose an acid scavenger that remains in the retentate, but does not pass over into the permeate and therefore eliminates the need for replenishment of acid scavenger or the need for a separation process to remove excess acid scavenger from the permeating solvent. Use of such an acid scavenger reduces isomerization and molecular weight degradation during the ultrafiltration process at room temperature but especially at elevated temperature, for example at a temperature in a range of about 10-190° C., 40-185° C., 50-180° C., or 60-175° C., particularly about 40-150° C. (for example 40-130° C.), more particularly about 60-140° C., even more particularly about 70-125° C., yet more particularly about 75-115° C.

Acid scavengers are particularly preferred stabilizers. Generally suitable is any scavenger that is capable of reacting with hydrogen halide, but does not interfere with subsequent utility of the (halogenated) copolymer, or can be removed from the (halogenated) copolymer prior to eventual end use. Useful acid scavengers include, for example epoxides.

Suitable epoxides are the products formed by epoxidizing esters and glycerides of C₈-C₂₄ unsaturated fatty acids, for example esters found in soybean oil, castor oil, linseed oil, safflower oil, etc. Preferred specific polyethers of this class include epoxidized soybean oil (ESBO) and epoxidized linseed oil (sold under the trademarks Drapex™ 6.8 and Drapex™ 10.4, respectively). Other suitable epoxides are monomeric low molecular weight, e.g., C₂-C₇, monofunctional epoxides, such as ethylene epoxide, propylene epoxide, butylene epoxide, etc. Preferred low molecular weight monofunctional epoxides include ethylene epoxide, propylene epoxide and butylene epoxide. Also suitable are aryl substituted alkyl epoxide, for example 1,2-epoxyethylbenzene, i.e., styrene epoxide.

The acid scavenger should be present in an amount which is effective to react with the hydrogen halide by-product formed during halogenation, taking into consideration reaction kinetics, e.g., temperature in the region in which the scavenger must react, the time available for the reaction compared to the potential for the acid halide to cause an undesirable side reaction (e.g. addition or degradation or isomerization), the use of additional means to remove hydrogen halide from the process (e.g., gas scrubbing, particularly in a process for halogenation of neat polymer), etc. Some limited experimentation, well within the skill of those in the art, will readily determine the effective amount of scavenger to be used in the particular circumstances at hand. As a general guide it will be recognized that in the absence of other means of removing hydrogen halide (e.g., gas scrubbing), one equivalent of scavenger is required at equilibrium per equivalent of hydrogen halide generated, but that as a practical matter up to about two to three times the theoretical amount can be used effectively. Where supplementary means are provided for hydrogen halide removal or where the effect of the hydrogen halide on the polymer is not particularly negative, as little as one-half or one-quarter the theoretical amount can be used effectively.

It is desirable that the molecular weight of the (halogenated) copolymers is relatively unchanged by the ultrafiltration process. The molecular weight decrease of polyisoolefin polymer following ultrafiltration is desirably less than 15%, more desirably less than 10%, even more desirably less than 5%. The choice of acid scavenger has been found to have an effect on molecular weight of the (halogenated) copolymers in the retentate.

In step B) a second organic medium comprising the (halogenated) copolymer of or obtainable from the retentate obtain in step A) and an organic diluent is contacted with an aqueous medium comprising at least one LCST compound having a cloud point of 0 to 100° C., preferably 5 to 100° C., more preferably 15 to 80° C. and even more preferably 20 to 70° C. and the organic diluent at least partially removed to obtain the pure (halogenated) copolymer.

As used herein at least partially means partially or fully.

In one embodiment the retentate obtained according to step A) is employed as second organic medium. In another, less preferred embodiment the (halogenated) copolymer is isolated from the retentate and redissolved in a organic diluent.

For the organic diluent used in the second organic medium the same definition as for the first organic medium given above applies as well including its preferred embodiments.

The aqueous medium may further contain non-LCST compounds selected from the group consisting of ionic or non-ionic surfactants, emulsifiers, and antiagglomerants in particular salts of mono- or multivaltent metal ions such as stearates or palmitates in particular those of sodium, potassium, calcium and zinc.

In one embodiment the aqueous medium therefore comprises 20.000 ppm or less, preferably 10.000 ppm or less, more preferably 8.000 ppm or less, even more preferably 5.000 ppm or less and yet even more preferably 2.000 ppm or less and in another yet even more preferred embodiment 1.000 ppm or less of non-LCST compounds whereby the non-LCST compounds are
selected from the group consisting of ionic or non-ionic surfactants, emulsifiers, and antiagglomerants or are in another embodiment
salts of (mono- or multivalent) metal ions or are in another embodiment
carboxylic acid salts of multivalent metal ions or are in another embodiment
stearates or palmitates of mono- or multivalent metal ions or are in another embodiment
calcium and zinc stearates or palmitates.

In one embodiment, the abovementioned amounts are with respect to the amount of (halogenated) copolymer present in the organic medium.

In another embodiment the aqueous medium comprises 500 ppm or less, preferably 100 ppm or less, more preferably 50 ppm or less, even more preferably 30 ppm or less and yet even more preferably 10 ppm or less and in another yet even more preferred embodiment 1.000 ppm or less of non-LCST compounds whereby the non-LCST compounds are
selected from the group consisting of ionic or non-ionic surfactants, emulsifiers, and antiagglomerants or are in another embodiment
salts of (mono- or multivalent) metal ions or are in another embodiment
carboxylic acid salts of multivalent metal ions or are in another embodiment
stearates or palmitates of mono- or multivalent metal ions or are in another embodiment
calcium and zinc stearates or palmitates.

In one embodiment, the abovementioned amounts are with respect to the amount of (halogenated) copolymer present in the second organic medium).

If not expressly stated otherwise ppm refers to parts per million by weight.

In one embodiment the aqueous medium comprises of from 0 to 5,000 ppm, preferably of from 0 to 2,000 ppm, more preferably of from 10 to 1,000 ppm, even more preferably of from 50 to 800 ppm and yet even more preferably of from 100 to 600 ppm of salts of mono or multivalent metal ions calculated on their metal content and with respect to the amount of (halogenated) copolymer present in the second organic medium.

In another embodiment the aqueous medium comprises of from 0 to 5,000 ppm, preferably of from 0 to 2,000 ppm, more preferably of from 10 to 1,000 ppm, even more preferably of from 50 to 800 ppm and yet even more preferably of from 100 to 600 ppm of salts of multivalent metal ions calculated on their metal content and with respect to the amount of (halogenated) copolymer present in the second organic medium.

In another embodiment the weight ratio of salts of stearates, palmitates and oleates of mono- and multivalent metal ions, if present, to the LCST compounds is of from 1:2 to 1:100, preferably 1:2 to 1:10 and more preferably of from 1:5 to 1:10 in the aqueous medium.

In one embodiment the aqueous medium comprises 550 ppm or less, preferably 400 ppm or less, more preferably 300 ppm or less, even more preferably 250 ppm or less and yet even more preferably 150 ppm or less and in another yet even more preferred embodiment 100 ppm or less of salts of metal ions calculated on their metal content and with respect to the amount of (halogenated) copolymer present in the second organic medium.

In yet another embodiment the aqueous medium comprises 550 ppm or less, preferably 400 ppm or less, more preferably 300 ppm or less, even more preferably 250 ppm or less and yet even more preferably 150 ppm or less and in another yet even more preferred embodiment 100 ppm or less of salts of multivalent metal ions calculated on their metal content and with respect to the amount of (halogenated) copolymer present in the second organic medium.

In one embodiment, the aqueous medium comprises 8.000 ppm or less, preferably 5.000 ppm or less, more preferably 2.000 ppm or less, yet even more preferably 1.000 ppm or less, in another embodiment preferably 500 ppm or less, more preferably 100 ppm or less and even more preferably 15 ppm or less and yet even more preferably no or from 1 ppm to 10 ppm of non-ionic surfactants being non-LCST compounds selected from the group consisting of ionic or non-ionic surfactants, emulsifiers, and antiagglomerants and with respect to the amount of (halogenated) copolymer present in the second organic medium.

As used herein a LCST compound is a compound which is soluble in a liquid medium at a lower temperature but precipitates from the liquid medium above a certain temperature, the so called lower critical solution temperature or LCST temperature. This process is reversible, so the system becomes homogeneous again on cooling down. The temperature at which the solution clarifies on cooling down is known as the cloud point (see German standard specification DIN EN 1890 of September 2006). This temperature is characteristic for a particular substance and a particular method.

Depending on the nature of the LCST compound which typically comprises hydrophilic and hydrophobic groups the determination of the cloud point may require different conditions as set forth in DIN EN 1890 of September 2006. Even though this DIN was originally developed for non-ionic surface active agents obtained by condensation of ethylene oxide this method allows determination of cloud points for a broad variety of LCST compounds as well. However, adapted conditions were found helpful to more easily determine cloud points for structurally different compounds.

Therefore the term LCST compound as used herein covers all compounds where a cloud point of 0 to 100° C., preferably 5 to 100° C., more preferably 15 to 80° C. and even more preferably 20 to 80° C. can be determined by at least one of the following methods:
1) DIN EN 1890 of September 2006, method A
2) DIN EN 1890 of September 2006, method C
3) DIN EN 1890 of September 2006, method E
4) DIN EN 1890 of September 2006, method A wherein the amount of compound tested is reduced from 1 g per 100 ml of distilled water to 0.05 g per 100 ml of distilled water.
5) DIN EN 1890 of September 2006, method A wherein the amount of compound tested is reduced from 1 g per 100 ml of distilled water to 0.2 g per 100 ml of distilled water.

In another embodiment the cloud points indicated above can be determined by at least one of the methods 1), 2) or 4).

As a consequence, non-LCST compounds are in general those compounds having either no cloud point or a cloud point outside the scope as defined hereinabove. It is apparent to those skilled in the art and known from various commercially available products, that the different methods described above may lead to slightly different cloud points. However, the measurements for each method are consistent and reproducible within their inherent limits of error and the general principle of the invention is not affected by different LCST temperatures determined for the same compound as long as with at least one of the above methods the cloud point is found to be within the ranges set forth above.

For the sake of clarity it should be mentioned that metal ions, in particular multivalent metal ions such as aluminum already stemming from the initiator system employed e.g. for the preparation of copolymers are not encompassed by the calculation of metal ions present in the aqueous medium employed in step B).

In another embodiment, the aqueous medium comprises 70 ppm or less, preferably 50 ppm or less, more preferably 30 ppm or less and even more preferably 20 ppm or less and yet even more preferably 10 ppm or less of salts of multivalent metal ions calculated on their metal content and with respect to the amount of (halogenated) copolymer present in the organic medium.

In yet another embodiment, the aqueous medium comprises 25 ppm or less, preferably 10 ppm or less, more preferably 8 ppm or less and even more preferably 7 ppm or less and yet even more preferably 5 ppm or less of salts of multivalent metal ions calculated on their metal content and with respect to the amount of (halogenated) copolymer in the the second organic medium.

In another embodiment, the aqueous medium comprises 550 ppm or less, preferably 400 ppm or less, more preferably 300 ppm or less, even more preferably 250 ppm or less and yet even more preferably 150 ppm or less and in another yet even more preferred embodiment 100 ppm or less of carboxylic acid salts of multivalent metal ions calculated on their metal content and with respect to the amount of (halogenated) copolymer in the second organic medium, whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as stearic acid.

The following example shows how the calculation is performed.

The molecular weight of calcium stearate (C₃₆H₇₀CaO₄) is 607.04 g/mol. The atomic weight of calcium metal is 40.08 g/mol. In order to provide e.g. 1 kg of an aqueous medium comprising 550 ppm of a salts of a multivalent metal ion (calcium stearate) calculated on its metal content (calcium) and with respect to the amount of (halogenated) copolymer in the second organic medium that is sufficient to form a slurry from a organic medium comprising 10 g of a (halogenated) copolymer the aqueous medium must comprise (607.04/40.08)×(550 ppm of 10 g)=83 mg of calcium stearate or 0.83 wt.-% with respect to the halogenated (halogenated) copolymer or 83 ppm with respect to the aqueous medium. The weight ratio of aqueous medium to (halogenated) copolymer in the second organic medium would in this case be 100:1.

In yet another embodiment, the aqueous medium comprises 70 ppm or less, preferably 50 ppm or less, more preferably 30 ppm or less and even more preferably 20 ppm or less and yet even more preferably 10 ppm or less of carboxylic acid salts of multivalent metal ions calculated on their metal content and with respect to the amount of (halogenated) copolymer in the second organic medium, whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as palmitic acid or stearic acid.

In yet another embodiment, the aqueous medium comprises 25 ppm or less, preferably 10 ppm or less, more preferably 8 ppm or less and even more preferably 7 ppm or less and yet even more preferably 5 ppm or less of carboxylic acid salts of multivalent metal ions calculated on their metal content and with respect to the amount of (halogenated) copolymer in the second organic medium, whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as stearic acid.

In one embodiment the aqueous medium is free of carboxylic acid salts of multivalent metal ions whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as stearic acid.

In another embodiment, the aqueous medium comprises 100 ppm or less, preferably 50 ppm or less, more preferably 20 ppm or less and even more preferably 15 ppm or less and yet even more preferably 10 ppm or less of salts of monovalent metal ions calculated on their metal content and with respect to the amount of (halogenated) copolymer in the second organic medium.

In another embodiment, the aqueous medium comprises additionally or alternatively 100 ppm or less, preferably 50 ppm or less, more preferably 30 ppm or less, even more preferably 20 ppm or less and yet even more preferably 10 ppm or less and in another yet even more preferred embodiment 5 ppm or less of carboxylic acid salts of monovalent metal ions such as sodium stearate, sodium palmitate and sodium oleate and potassium stearate, potassium palmitate and potassium oleate calculated on their metal content and with respect to the amount of (halogenated) copolymer in the second organic medium, whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as stearic acid. Examples of monovalent salts of carboxylic acids include sodium stearate, palmitate and oleate as well as potassium stearate, palmitate and oleate.

In one embodiment the aqueous medium is free of carboxylic acid salts of monovalent metal ions whereby the carboxylic acids are selected from those having 6 to 30 carbon atoms, preferably 8 to 24 carbon atoms, more preferably 12 to 18 carbon atoms. In one embodiment such carboxylic acids are selected from monocarboxylic acids. In another embodiment such carboxylic acids are selected from saturated monocarboxylic acids such as palmitic or stearic acid.

In another embodiment the aqueous medium comprises of from 0 to 5,000 ppm, preferably of from 0 to 2,000 ppm, more preferably of from 10 to 1,000 ppm, even more preferably of from 50 to 800 ppm and yet even more preferably of from 100 to 600 ppm of
carbonates of multivalent metal ions calculated on their metal content and with respect to the amount of (halogenated) copolymer in the second organic medium or in another embodiment of
magnesium carbonate and calcium carbonate calculated on their metal content
   and with respect to the amount of (halogenated) copolymer in the second organic medium.

In another embodiment, the aqueous medium comprises comprises 550 ppm or less, preferably 400 ppm or less, more preferably 300 ppm or less, even more preferably 250 ppm or less and yet even more preferably 150 ppm or less and in another yet even more preferred embodiment 100 ppm or less of
carbonates of multivalent metal ions calculated on their metal content and with respect to the amount of (halogenated) copolymer in the second organic medium or in another embodiment of
magnesium carbonate and calcium carbonate calculated on their metal content and with respect to the amount of (halogenated) copolymer in the second organic medium.

In yet another embodiment, the aqueous medium comprises 70 ppm or less, preferably 50 ppm or less, more preferably 30 ppm or less and even more preferably 20 ppm or less and yet even more preferably 10 ppm or less of
carbonates of multivalent metal ions calculated on their metal content and with respect to the amount of copolymer present in the organic medium obtained according to step b) or in another embodiment of
magnesium carbonate and calcium carbonate calculated on their metal content
   and with respect to the amount of (halogenated) copolymer in the second organic medium.

The term multivalent metal ions encompasses in particular bivalent earth alkaline metal ions such as magnesium, calcium, strontium and barium, preferably magnesium and calcium, trivalent metal ions of group 13 such as aluminium, multivalent metal ions of groups 3 to 12 in particular the bivalent metal ion of zinc.

The term monovalent metal ions encompasses in particular alkaline metal ions such as lithium, sodium and potassium.

In another embodiment, the aqueous medium comprises 500 ppm or less, preferably 200 ppm or less, more preferably 100 ppm or less, even more preferably 50 ppm or less and yet even more preferably 20 ppm or less and in another yet even more preferred embodiment no layered minerals such as talcum calculated with respect to the amount of (halogenated) copolymer in the second organic medium.

In another embodiment, the aqueous medium comprises 500 ppm or less, preferably 200 ppm or less, more preferably 100 ppm or less, even more preferably 20 ppm or less and yet even more preferably 10 ppm or less and in another yet even more preferred embodiment 5 ppm or less and yet even more preferably no dispersants, emulsifiers or anti-agglomerants other than the LCST compounds.

According to step B) the pure (halogenated) copolymer is obtained in form of an aqueous slurry comprising a plurality of particles of the (halogenated) copolymer suspended therein.

The term “plurality” denotes an integer of at least two, preferably at least 20, more preferably at least 100.

In one embodiment the expression “aqueous slurry comprising a plurality of (halogenated) copolymer particles suspended therein” denotes a slurry having at least 10 discrete particles per liter suspended therein, preferably at least 20 discrete particles per liter, more preferably at least 50 discrete particles per liter and even more preferably at least 100 discrete particles per liter.

The term (halogenated) copolymer particles denote discrete particles of any form and consistency, which in a preferred embodiment have a particle size of between 0.05 mm and 25 mm, more preferably between 0.1 and 20 mm.

In one embodiment the weight average particle size of the (halogenated) copolymer particles is from 0.3 to 10.0 mm.

It is apparent to those skilled in the art, that the (halogenated) copolymer formed according to the invention may still contain organic diluent and further may contain water encapsulated within the (halogenated) copolymer. In one embodiment the (halogenated) copolymer contains 90 wt.-% or more of the (halogenated) copolymer calculated on the sum of organic diluent and (halogenated) copolymer, preferably 93 wt.-% or more, more preferably 94 wt.-% or more and even more preferably 96 wt.-% or more.

Particles of (halogenated) copolymer are often referred to as crumbs in the literature. Typically the (halogenated) copolymer particles or crumbs have non-uniform shape and/or geometry.

The term aqueous medium denotes a medium comprising 80 wt.-% or more of water, preferably 90 wt.-% or more 80 wt.-% and even more preferably 95 wt.-% or more of water and yet even more preferably 99 wt.-% or more.

The remainder to 100 wt.-% includes the LCST compounds and may further include compounds selected from the group of
non-LCST compounds as defined above
compounds and salts which are neither an LCST compound nor a non-LCST compound as defined above
organic diluents to the extent dissolvable in the aqueous medium
where an extended shelf life of the product is desired antioxidants and/or stabilizers.

In one embodiment the aqueous phase comprises of from 1 to 2,000 ppm of antioxidants, preferably of from 50 to 1,000 ppm more preferably of from 80 to 500 ppm calculated with respect to the amount of (halogenated) copolymer in the second organic medium.

Where desired to obtain very pure (halogenated) copolymers the water employed to prepare the aqueous phase is demineralized by standard procedure such as ion-exchange, membrane filtration techniques such as reverse osmosis and the like.

Typically application of water having a degree of 8.0 german degrees of hardness (° dH) hardness or less, preferably 6.0° dH or less, more preferably 3.75° dH or less and even more preferably 3.00° dH or less is sufficient.

In one embodiment the water is mixed with the at least one LCST compounds to obtain a concentrate which is depending on the temperature either a slurry or a solution having a LCST-compound concentration of from 0.1 to 2 wt.-%, preferably 0.5 to 1 wt.-%. This concentrate is then metered into and diluted with more water in the vessel in which step A) is performed to the desired concentration.

Preferably the concentrate is a solution and metered into the vessel having a temperature of from 0 to 35° C., preferably 10 to 30° C.

If not mentioned otherwise, ppm refer to weight.-ppm.

The aqueous medium may further contain antioxidants and/or stabilizers:

Antioxidants and stabilizers include 2,6-di-tert.-butyl-4-methyl-phenol (BHT) and pentaerythrol-tetrakis-[3-(3,5-di-tert.-butyl-4-hydroxyphenyl)-propanoic acid (also known as Irganox® 1010), octadecyl 3,5-di(tert)-butyl-4-hydroxyhydrocinnamate (also known as Irganox® 1076), tert-butyl-4-hydroxy anisole (BHA), 2-(1,1-dimethyl)-1,4-benzenediol (TBHQ), tris(2,4,-di-tert-butylphenyl)phosphate (Irgafos® 168), dioctyldiphenylamine (Stalite® S), butylated products of p-cresol and dicyclopentadiene (Wingstay) as well as other phenolic antioxidants and hindered amine light stabilizers.

Suitable antioxidants generally include 2,4,6-tri-tert-butylphenol, 2,4,6 tri-isobutylphenol, 2-tert-butyl-4,6-dimethylphenol, 2,4-dibutyl-6-ethylphenol, 2,4-dimethyl-6-tert-butylphenol, 2,6-di-tert-butylhydroyxytoluol (BHT), 2,6-di-tert-butyl-4-ethylphenol, 2,6-di-tert-butyl-4-n-butylphenol, 2,6-di-tert-butyl-4-iso-butylphenol, 2,6-dicyclopentyl-4-methylphenol, 4-tert-butyl-2,6-dimethylphenol, 4-tert-butyl-2,6-dicyclopentylphenol, 4-tert-butyl-2,6-diisopropylphenol, 4,6-di-tert-butyl-2-methylphenol, 6-tert-butyl-2,4-dimethylphenol, 2,6-di-tert-butyl-3-methylphenol, 4-hydroxymethyl-2,6-di-tert-butylphenol, 2,6-di-tert-butyl-4-phenylphenol and 2,6-dioctadecyl-4-methylphenol, 2,2′-ethylidene-bis[4,6-di-tert.-butylphenol], 2,2′-ethylidene-bis[6-tert.-butyl-4-isobutylphenol], 2,2′-isobutylidene-bis[4,6-dimethylphenol], 2,2′-methylene-bis[4,6-di-tert.-butylphenol], 2,2′-methylene-bis[4-methyl-6-(α-methylcyclohexyl)phenol], 2,2′-methylene-bis[4-methyl-6-cyclohexylphenol], 2,2′-methylene-bis[4-methyl-6-nonylphenol], 2,2′-methylene-bis[6-(α,α-dimethylbenzyl)-4-nonylphenol], 2,2′-methylene-bis[6-(α-methylbenzyl)-4-nonylphenol], 2,2′-methylene-bis[6-cyclohexyl-4-methylphenol], 2,2′-methylene-bis[6-tert.-butyl-4-ethylphenol], 2,2′-methylene-bis[6-tert.-butyl-4-methylphenol], 4,4′-butylidene-bis[2-tert.-butyl-5-methylphenol], 4,4′-methylene-bis[2,6-di-tert.-butylphenol], 4,4′-methylene-bis[6-tert.-butyl-2-methylphenol], 4,4′-isopropylidene-diphenol, 4,4′-decylidene-bisphenol, 4,4′-dodecylidene-bisphenol, 4,4′-(1-methyloctylidene)bisphenol, 4,4′-cyclohexylidene-bis(2-methylphenol), 4,4′-cyclohexylidenebisphenol, and pentaerythrol-tetrakis-[3-(3,5-di-tert.-butyl-4-hydroxyphenyl)-propanoic acid (also known as Irganox® 1010).

Suitable stabilizers, in particular for brominated copolymers include epoxidized unsaturated oils such as epoxidized linseed oil or epoxidized soybean oil, whereby the latter is preferred.

Antioxidants and/or stabilizers may, in one embodiment, be alternatively or additionally also present or added to the organic medium before performing step A).

In one embodiment antioxidants are added to the aqueous medium and the stabilizers are present or are added to the second organic medium.

In step B) the second organic medium is contacted with an aqueous medium comprising at least one LCST compound having a cloud point of 0 to 100° C., preferably 5 to 100° C., more preferably 15 to 80° C. and even more preferably 20 to 70° C. and removing at least partially the organic diluent to obtain the (halogenated) copolymer.

The contact can be performed in any vessel suitable for this purpose. In industry such contact is typically performed in a flash drum or any other vessel known for separation of a liquid phase and vapours.

Removal of organic diluent may also employ other types of distillation so to subsequently or jointly remove the residual monomers and the organic diluent to the desired extent. Distillation processes to separate liquids of different boiling points are well known in the art and are described in, for example, the Encyclopedia of Chemical Technology, Kirk Othmer, 4th Edition, pp. 8-311, which is incorporated herein by reference. Generally, the organic diluent may either be separately or jointly be recycled into a step i) of a halogenation reaction.

The pressure in step B) and in one embodiment the steam-stripper or flash drum depends on the organic diluent but is typically in the range of from 100 hPa to 5,000 hPa.

The temperature in step B) is selected to be sufficient to at least partially remove the organic diluent.

In one embodiment the temperature is from 10 to 100° C., preferably from 50 to 100° C., more preferably from 60 to 95° C. and even more preferably from 75 to 95° C.

Upon contact of the organic medium with the aqueous medium comprising at least one LCST compound (halogenated) copolymer particles suspended in the aqueous slurry are formed.

According to the observations of the applicant and without wanting to be bound by theory a further consequence is that the at least LCST compound as earlier observed for conventional anti-agglomerants such as calcium stearate, the aqueous medium comprising the at least one LCST compound depletes from LCST compounds so that in the final aqueous slurry at least a part, according to the observations disclosed in the experimental part a substantial part of the LCST compounds are part of the (halogenated) copolymer particles and are presumably bound to the surface of the (halogenated) copolymer particles causing the tremendous anti-agglomerating effect.

Suitable LCST compounds are for example selected from the group consisting of:

poly(N-isopropylacrylamide), poly(N-isopropylacrylamide-co-N,N-dimethylacrylamide, poly(N-isopropylacrylamide)-alt-2-hydroxyethylmethacrylate, poly(N-vinylcaprolactam), poly(N,N-diethylacrylamide), poly[2-(dimethylamino)ethyl methacrylate], poly(2-oxazoline) glycopolymers, Poly(3-ethyl-N-vinyl-2-pyrrolidone), hydroxylbutyl chitosan, polyoxyethylene (20) sorbitan monostearate, polyoxyethylene (20) sorbitan monolaurate, polyoxyethylene (20) sorbitan monooleate, methyl cellulose, hydroxypropyl cellulose, hydroxyethyl methylcellulose, hydroxypropyl methylcellulose, poly(ethylene glycol) methacrylates with 2 to 6 ethylene glycol units, polyethyleneglycol-co-polypropylene glycols, preferably those with 2 to 6 ethylene glycol units and 2 to 6 polypropylene units, compounds of formula (I)

HO—[—CH₂—CH₂—O]ₓ—[—CH(CH₃)—CH₂—O]_{y}—[—CH₂—CH₂—O]_{z}—H (I)

with y=3 to 10 and x and z=1 to 8, whereby y+x+z is from 5 to 18,
polyethyleneglycol-co-polypropylene glycol, preferably those with 2 to 8 ethylene glycol units and 2 to 8 polypropylene units, ethoxylated iso-C₁₃H₂₇-alcohols, preferably with an ethoxylation degree of 4 to 8, polyethylene glycol with 4 to 50, preferably 4 to 20 ethyleneglycol units, polypropylene glycol with 4 to 30, preferably 4 to 15 propyleneglycol units, polyethylene glycol monomethyl, dimethyl, monoethyl and diethyl ether with 4 to 50, preferably 4 to 20 ethyleneglycol units, polypropylene glycol monomethyl, dimethyl, monoethyl and diethyl ether with 4 to 50, preferably 4 to 20 propyleneglycol units, whereby methyl cellulose, hydroxypropyl cellulose, hydroxyethyl methylcellulose and hydroxypropyl methylcellulose are preferred.

In one embodiment methyl cellulose, hydroxypropyl cellulose, hydroxyethyl methylcellulose and hydroxypropyl methylcellulose have a degree of substitution of from 0.5 to 2.8 the theoretical maximum being 3, preferably 1.2 to 2.5 and more preferably 1.5 to 2.0.

In one embodiment hydroxypropyl cellulose, hydroxyethyl methylcellulose and hydroxypropyl methylcellulose have a MS (moles of substitution) of from 3, preferably of from 4, more preferably of from 4 to 20 with respect to ethylene glycol or propylene glycol groups per glucose unit.

The amount of LCST compound(s) present in the aquous medium employed in step A) is for example of from 1 to 20,000 ppm, preferably 3 to 10,000 ppm, more preferably 5 to 5,000 ppm and even more preferably 10 to 5,000 ppm with respect to the amount of (halogenated) copolymer in the second organic medium.

In one embodiment the LCST compounds exhibit a molecular weight of at least 1,500 g/mol, preferably at least 2,500 g/mol and more preferably at least 4,000 g/mol.

Where a mixture of different LCST compounds is applied the weight average molecular weight is for example of from 1,500 to 2,000,000.

The unique capability of the LCST compounds to stabilize (halogenated) copolymer particles in aqueous solution is a major finding of the invention. The invention therefore also encompasses a method to prevent or reduce or to slow-down agglomeration of slurries comprising (halogenated) copolymer particles suspended in aqueous media by addition or use of LCST compounds having a cloud point of 0 to 100° C., preferably 5 to 100° C., more preferably 15 to 80° C. and even more preferably 20 to 70° C.

The at least partial removal of the organic diluent typically requires significant amounts of heat to balance the heat of evaporation which can be provided for example by heating the vessel wherein step B) is performed either from outside or in a preferred embodiment additionally or alternatively by introducing steam which further aids removal of organic diluent and to the extent still present after polymerization the monomers (steam stripping).

Step B) may be carried out batchwise or continuously, whereby a continuous operation is preferred.

In one embodiment the temperature of the resulting slurry obtained in step B) is from 50 to 100° C., preferably from 60 to 100° C., more preferably from 70 to 95° C. and even more preferably from 75 to 95° C.

Even found not to be necessary in one embodiment the temperature in step B) is above the highest determined cloud point of the at least one LCST compound employed.

Highest determined cloud point means the highest cloud point measured with the three methods disclosed above. If a cloud point cannot be determined for whatever reason with one or two methods the highest cloud point of the other determinations is taken as the highest determined cloud point.

In one embodiment the removal of the organic diluent is performed until the aqueous slurry comprises less than 10 wt.-% of organic diluent calculated on the (halogenated) copolymer contained in the (halogenated) copolymer particles of the resulting aqueous slurry, preferably less than 7 wt.-% and even more preferably less than 5 wt.-% and yet even more preferably less than 3 wt.-%.

It was not known before and is highly surprising that (halogenated) copolymer particles with very low levels or even absence of antiagglomerants selected from carboxylic acid salts of mono- or multivalent metal ions and layered minerals can be obtained at all.

The aqueous slurries disclosed hereinabove and as obtainable according to step B) as such are therefore also encompassed by the invention.

The aqueous slurries obtained according to step B) serve as an ideal starting material to obtain the (halogenated) copolymers in isolated form.

Therefore, in a further step C) the (halogenated) copolymer particles contained in the aqueous slurry obtained according to step B) may be separated to obtain the (halogenated) copolymers.

The separation may be effected by flotation, centrifugation, filtration, dewatering in a dewatering extruder or by any other means known to those skilled in the art for the separation of solids from fluids.

In one embodiment the separated aqueous phase is recycled into step B) if required after replacement of LCST-compounds, water and optionally other components which were removed with the (halogenated) copolymer particles.

In a further step D) the (halogenated) copolymers obtained according to step C) are dried, preferably to a residual content of volatiles of 7,000 or less, preferably 5,000 or less, even more preferably 4,000 or less and in on other embodiment 2,000 ppm or less, preferably 1,000 ppm or less.

It has been observed that after step D, material produced according to the invention without the use of calcium stearate shows reduced fines in the finishing process when compared to material produced according to standard methods. Reducing fines shows advantages in fouling and reduced cleaning frequency required in step D).

Where desired, e.g. to produce perform-alike products having usual levels of multivalent stearates or palmitates, in particular calcium stearate and palmitate or zinc stearate and palmitate, these multivalent stearates or palmitates may be added to the (halogenated) copolymer particles obtained according to the invention e.g. at step C) or D), preferably step C). This may be effected e.g. in step e) by spraying aqueous suspensions of said multivalent stearates and/or palmitates onto the (halogenated) copolymer particles. Multivalent stearates and/or palmitates, in particular calcium and/or zinc stearate and/or palmitate may also be added at any point or step after the formation of the aqueous slurry of (halogenated) copolymers particles according to step B).

It is also possible to realize certain advantages of the LCST agents by adding at least one LCST agent to a production process using anti-agglomerants known in the prior art for step B): In particular agglomeration of (halogenated) copolymer particles in an aqueous slurries produced through use of multivalent stearates and/or palmitates such as calcium and/or zinc stearate and/or palmitate can be substantially delayed through the addition of at least one LCST agent after formation of (halogenated) copolymer particles.

As a consequence the invention encompasses also the general use of LCST compounds, including their preferred embodiments, in processing of (halogenated) copolymers.

As used herein the term volatiles denotes compounds having a boiling point of below 250° C., preferably 200° C. or less at standard pressure and include water as well as remaining organic diluents.

Drying can be performed using conventional means known to those in the art, which includes drying on a heated mesh conveyor belt.

Depending on the drying process the (halogenated) copolymers may also be brought into a different shape such as pellets.

However the term (halogenated) copolymers encompasses any type of (halogenated) copolymers irrespective of its shape as long as the parameter defined herein are fulfilled.

Such (halogenated) copolymers are also encompassed by the invention and for example obtained by drying in an extruder followed by pelletizing at the extruder outlet. Such pelletizing may also be performed under water. The process according to the invention allows preparation of h(halogenated) copolymers having a tunable or if desired an unprecedented low level of mono- and multivalent metal ions and cyclic polymers.

The invention therefore encompasses (halogenated) copolymer products having a (halogenated) copolymer content of 98.5 wt.-% or more, preferably 98.8 wt.-% or more, more preferably, 99.0 wt.-% or more even more preferably 99.2 wt.-% or more, yet even more preferably 99.4 wt.-% or more and in another embodiment 99.5 wt.-% or more preferably 99.7 wt.-% or more having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer.

In one embodiment the (halogenated) copolymer products comprise 550 ppm or less, preferably 400 ppm or less, more preferably 300 ppm or less, even more preferably 250 ppm or less and yet even more preferably 150 ppm or less and in another yet even more preferred embodiment 100 ppm or less of salts of mono- or multivalent metal ions calculated on their metal content.

In one embodiment the (halogenated) copolymers comprise 5000 ppm or less, preferably 2.000 ppm or less, more preferably 1.000 ppm or less, even more preferably 500 ppm or less and yet even more preferably 100 ppm or less and in another yet even more preferred embodiment 50 ppm or less, preferably 50 ppm or less more preferably 10 ppm or less and yet even more preferably no non-LCST compounds whereby the non-LCST compounds are
selected from the group consisting of ionic or non-ionic surfactants, emulsifiers, and antiagglomerants or are in another embodiment
salts of (mono- or multivalent) metal ions or are in another embodiment
carboxylic acid salts of multivalent metal ions or are in another embodiment
stearates or palmitates of mono- or multivalent metal ions or are in another embodiment
calcium and zinc stearates or palmitates.

In another aspect the invention provides (halogenated) copolymer products comprising salts of multivalent metal ions in an amount of of 500 ppm or less, preferably 400 ppm or less, more preferably 250 ppm or less, even more preferably 150 ppm or less and yet even more preferably 100 ppm or less and in an even more preferred embodiment 50 ppm or less calculated on their metal content.

The (halogenated) copolymer products may further comprise antioxidants such as 2,6-di-tert.-butyl-4-methyl-phenol (BHT) and pentaerythrol-tetrakis-[3-(3,5-di-tert.-butyl-4-hydroxyphenyl)-propanoic acid (also known as Irganox® 1010), for example in an amount of from 50 ppm to 1000 ppm, preferably of from 80 ppm to 500 ppm and in another embodiment of from 300 ppm to 700 ppm.

The (halogenated) copolymer products may further comprise stabilizers, in particular for brominated copolymers such as epoxidized unsaturated oils such as epoxidized linseed oil or epoxidized soybean oil, whereby the latter is preferred. Such stabilizers are for example present in an amount of from 0.05 to 2.50 wt.-%, preferably 0.20 to 1.50 wt.-% and in another embodiment of from 0.50 to 1.50 wt.-%.

Typically the remainder to 100 wt.-% include the LCST compound(s), volatiles, to the extent employed at all salts of multivalent metal ions as well as low levels of residual monovalent metal ion salts such as sodium chloride.

In one embodiment the amount of LCST compounds present in the (halogenated) copolymer products is from 1 ppm to 18,000 ppm, preferably of from 1 ppm to 10,000 ppm, more preferably 1 ppm to 5,000 ppm, even more preferably from 1 ppm to 2,000 ppm and in a more preferred embodiment from 5 to 1,000 ppm or from 5 to 500 ppm.

In one embodiment the amount of salts of monovalent metal ions present in the (halogenated) copolymer products is from 1 ppm to 1,000 ppm, preferably from 10 ppm to 500 ppm and in a more preferred embodiment from 10 to 200 ppm.

In one embodiment the amount of stearates or palmitates of mono- or multivalent metal ions present in the (halogenated) copolymer products is 0 to 4,000 ppm, preferably 0 to 2,000 ppm, more preferably 0 to 1,000 ppm and in a more preferred embodiment from 0 to 500 ppm.

In one embodiment the amount of LCST compounds present in the (halogenated) copolymer products is from 1 ppm to 5,000 ppm, preferably from 1 ppm to 2,000 ppm and in a more preferred embodiment from 5 to 1,000 ppm or from 5 to 500 ppm.

In one embodiment the amount of stearates or palmitates of multivalent metal ions present in the (halogenated) copolymer products is 0 to 4,000 ppm, preferably 0 to 2,000 ppm, more preferably 0 to 1,000 ppm and in a more preferred embodiment from 0 to 500 ppm.

In one embodiment the invention therefore encompasses (halogenated) copolymer products comprising
I) 96.0 wt.-% or more, preferably 97.0 wt.-% or more, more preferably, 98.0 wt.-% or more even more preferably 99.0 wt.-% or more, yet even more preferably 99.2 wt.-% or more and in another embodiment 99.5 wt.-% or more of a (halogenated) copolymer having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer
II) 0 to 3.0 wt.-%, preferably 0 to 2.5 wt.-%, more preferably 0 to 1.0 wt.-% and more preferably 0 to 0.40 wt.-% of salts of mono- or multivalent metal ions, preferably stearates and palmitates of multivalent metal ions and
III) 1 ppm to 5,000 ppm, preferably from 1 ppm to 2,000 ppm and in a more preferred embodiment from 5 to 1,000 ppm or from 5 to 500 ppm of at least one LCST compound.

In yet another embodiment the invention encompasses (halogenated) copolymers comprising
I) 100 parts by weight of a (halogenated) copolymer having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer
II) 0.0001 to 0.5, preferably 0.0001 to 0.2, more preferably 0.0005 to 0.1, even more preferably 0.0005 to 0.05 parts by weight of a least one LCST compound and
III) no or from 0.0001 to 3.0, preferably no or from 0.0001 to 2.0, more preferably no or from 0.0001 to 1.0, even more preferably no or from 0.0001 to 0.5, yet even more preferably no or from 0.0001 to 0.3, and most preferably no or from 0.0001 to 0.2 parts by weight of salts of mono- or multivalent metal ions, preferably stearates and palmitates of mono- or multivalent metal ions, preferably comprising calcium stearate, calcium palmitate, zinc stearate or zinc palmitate and
IV) no or from 0.005 to 0.3, preferably 0.05 to 0.1, more preferably from 0.008 to 0.05 and yet more preferably from 0.03 to 0.07 parts by weight of antioxidants
V) from 0.005 to 1.5, preferably 0.05 to 1.0, more preferably 0.005 to 0.5, even more preferably from 0.01 to 0.3 and yet even more preferably from 0.05 to 0.2 parts by weight of volatiles having a boiling point at standard pressure of 200° C. or less.

In another embodiment the (halogenated) copolymer products further comprise
VI) from 0.05 to 2.5, preferably from 0.20 to 1.50, more preferably from 0.50 to 1.50 parts by weight and even more preferably 0.75 to 1.50 parts by weight of stabilizers, preferably epoxidized compounds, preferably epoxidized unsaturated oils such as epoxidized linseed oil or epoxidized soybean oil, whereby the latter is preferred.

Preferably the aforementioned components I) to V) add up to 100.00501 to 105.300000 parts by weight, preferably 100.00501 to 104.100000 parts by weight, more preferably from 100.01 to 103.00 parts by weight, even more preferably from 100.10 to 101.50 parts by weight, yet even more preferably from 100.10 to 100.80 parts by weight and together represent 99.50 to 100.00 wt.-% or, in another embodiment, 99.80 to 100.00 wt.-%, preferably 99.90 to 100.00 wt.-%, more preferably 99.95 to 100.00 wt.-% and yet even more preferably 99.97 to 100.00 wt.-% of the total weight of the (halogenated) copolymer product.

In another embodiment the aforementioned components I) to VI) add up to 100.05501 to 107.800000 parts by weight, preferably 100.05501 to 106.600000 parts by weight, preferably from 100.21 to 104.50 parts by weight, more preferably from 100.60 to 103.00 parts by weight, even more preferably from 100.85 to 102.30 parts by weight and together represent 99.50 to 100.00 wt.-% or, in another embodiment, 99.80 to 100.00 wt.-%, preferably 99.90 to 100.00 wt.-%, more preferably 99.95 to 100.00 wt.-% and yet even more preferably 99.97 to 100.00 wt.-% of the total weight of the (halogenated) copolymer product.

The remainder, if any, may represent salts or components which are none of the aforementioned components and e.g. stemming from the water employed to prepare the aqueous phase used in step A) or other components stemming e.g. from post-polymerization modifications.

Since salts of multivalent metal ions contribute to the ash content measurable according to ASTM D5667 (reapproved version 2010) the invention further encompasses (halogenated) copolymer products comprising 97.5 wt.-% or more, preferably 98.0 wt.-% or more, more preferably, 98.2 wt.-% or more even more preferably 98.4 wt.-% or more, yet even more preferably 98.5 wt.-% or more and in another embodiment 99.5 wt.-% or more of a (halogenated) copolymer having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer and having an ash content measured according to ASTM D5667 of 0.25 wt.-% or less, preferably 0.15 wt.-% or less, more preferably 0.10 wt.-% or less and even more preferably 0.05 wt.-% or less.

In a preferred embodiment the aforementioned (halogenated) copolymer products, further comprise 1 ppm to 5,000 ppm, preferably from 1 ppm to 2,000 ppm and in a more preferred embodiment from 5 to 1,000 ppm or from 5 to 500 ppm of a least one LCST compound.

For all (halogenated) copolymer products described above and hereinbelow in one embodiment, additionally the ash content measured according to ASTM D5667 is for example 0.25 wt.-% or less, preferably 0.15 wt.-% or less, more preferably 0.10 wt.-% or less and even more preferably 0.05 wt.-% or less.

In yet another embodiment the invention encompasses (halogenated) copolymer products comprising
I) 96.0 wt.-% or more, preferably 97.0 wt.-% or more, more preferably, 98.0 wt.-% or more even more preferably 99.0 wt.-% or more, yet even more preferably 99.2 wt.-% or more and in another embodiment 99.5 wt.-% or more of a (halogenated) copolymer having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer and
II) 1 ppm to 5,000 ppm, preferably from 1 ppm to 2,000 ppm and in a more preferred embodiment from 5 to 1,000 ppm or from 5 to 500 ppm of at least one LCST compound,
   whereby the (halogenated) copolymer products further have an ash content measured according to ASTM D5667 of 0.25 wt.-% or less, preferably 0.15 wt.-% or less, more preferably 0.10 wt.-% or less and even more preferably 0.05 wt.-% or less.

In yet another embodiment the invention encompasses (halogenated) copolymer products comprising
I) 100 parts by weight of a (halogenated) copolymer (phr) having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the (halogenated) copolymer
II) 0.0001 to 0.5, preferably 0.0001 to 0.2, more preferably 0.0005 to 0.1, even more preferably 0.0005 to 0.05 parts by weight (phr) of a least one LCST compound and
III) no or from 0.005 to 0.3, preferably 0.005 to 0.1, more preferably from 0.008 to 0.05, even more preferably from 0.03 to 0.07 parts by weight (phr) of antioxidants
IV) from 0.005 to 1.5, preferably 0.05 to 1.0, more preferably 0.005 to 0.5, even more preferably from 0.01 to 0.3 and yet more preferably from 0.05 to 0.2 parts by weight (phr) of volatiles having a boiling point at standard pressure of 200° C. or less
   whereby the (halogenated) copolymer products further have an ash content measured according to ASTM D5667 of 0.25 wt.-% or less, preferably 0.15 wt.-% or less, more preferably 0.10 wt.-% or less and even more preferably 0.05 wt.-% or less.

In another embodiment the aforementioned (halogenated) copolymer products further comprise
V) from 0.05 to 2.5, preferably from 0.20 to 1.50, more preferably from 0.50 to 1.50 parts by weight and even more preferably 0.75 to 1.50 parts by weight of stabilizers, preferably epoxidized compounds, preferably epoxidized unsaturated oils such as epoxidized linseed oil or epoxidized soybean oil, whereby the latter is preferred.

Preferably the aforementioned components I) to IV) add up to 100.00501 to 102.300000 parts by weight and together represent 99.00 to 100.00 wt.-% or, in another embodiment, 99.50 to 100.00 wt.-%, preferably 99.70 to 100.00 wt.-% of the total weight of the (halogenated) copolymer product.

In another embodiment the aforementioned components I) to V) add up to 100.05501 to 105.800000 parts by weight and together represent 99.00 to 100.00 wt.-% or, in another embodiment, 99.50 to 100.00 wt.-%, preferably 99.70 to 100.00 wt.-% of the total weight of the (halogenated) copolymer product.

Determination of free carboxylic acids and their salts, in particular calcium and zinc stearate or palmitate can be accomplished by measurement using Gas Chromatography with a Flame Ionization Detector (GC-FID) according to the following procedure:

2 g of a sample of (halogenated) copolymer product are weight out to the nearest 0.0001 g, placed in a 100 mL jar and combined with
a) 25 mL hexane, 1,000 mL of an internal standard solution where levels of free carboxylic acids are to be determined and
b) 25 mL hexane, 1,000 mL of an internal standard solution and 5 drops of concentrated sulfuric acid where levels of carboxylic acid salts are to be determined.

The jar is put on a shaker for 12 hours. Then 23 ml acetone are added and the remaining mixture evaporated to dryness at 50° C. which takes typically 30 minutes.

Thereafter 10 ml methanol and 2 drops of concentrated sulfuric acid are added, shaken to mix and heated for 1 hour to 50° C. to convert the carboxylic acids into their methyl esters. Thereafter 10 ml hexane and 10 ml demineralized water are added, vigorously shaken and finally the hexane layer is allowed to separate. 2 ml of the hexane solution are used for GC-FID analysis.

It is known to those skilled in the art that technical stearates such as calcium and zinc stearate also contain fractions of other calcium and zinc carboxylic acid salts such as palmitates. However, GC-FID allows to determine the contents of other carboxylic acids as well.

Direct measurement of carboxylic acid salts in particular stearates and palmitates can be accomplished by FTIR as follows: A sample of rubber is pressed between two sheets of silicon release paper in a paper sample holder and analyzed on an infrared spectrometer. Calcium stearate carbonyl peaks are found at 1541.8 &1577.2 cm⁻¹. The peaks of heat converted calcium stearate (a different modification of calcium stearate, see e.g. Journal of Colloid Science Volume 4, Issue 2, April 1949, Pages 93-101) are found at 1562.8 and 1600.6 cm⁻¹ and are also included in the calcium stearate calculation. These peaks are ratioed to the peak at 950 cm⁻¹ to account for thickness variations in the samples.

By comparing peak heights to those of known standards with predetermined levels of calcium stearate, the concentrations of calcium stearate can be determined. The same applies to other carboxylic acid salts in particular stearates and palmitates as well. For example, a single zinc stearate carbonyl peak is found at 1539.5 cm⁻¹, for sodium stearate a single carbonyl peak is found at 1558.5 cm⁻¹.

Contents of mono- or multivalent metal ions, in particular multivalent metal ions such as calcium and zinc contents can generally be determined and were determined if not mentioned otherwise by Inductively coupled plasma atomic emission spectrometry (ICP-AES) according to EPA 6010 Method C using NIST traceable calibration standards after microwave digestion according to EPA 3052 method C.

Additionally or alternatively contents of various elements can be determined by X-ray fluorescence (XRF). The sample is irradiated with X-ray radiation of sufficient energy to excite the elements of interest. The elements will give off energy specific to the element type which is detected by an appropriate detector. Comparison to standards of known concentration and similar matrix will give quantitation of the desired element. Contents of LCST compounds, in particular methyl cellulose contents are measurable and were measured using Gel Filtration Chromatography on a Waters Alliance 2690/5 separations module equipped with a PolySep-GFC-P4000, 300×7.8 mm aqueous GFC column and a PolySep-GFC-P4000, 35×7.8 mm guard column and a Waters 2414 Differential Refractometer against standards

of known concentration. As gel filtration chromatography separates based on molecular weight, it may be necessary to employ different columns than those mentioned above in order to analyze for LCST compounds across different molecular weight ranges.

The samples are for example prepared according to the following procedure:

2 g of a sample of (halogenated) polymer product are weighed to the nearest 0.0001 g and dissolved in 30 ml hexanes using a shaker at low speed overnight in a closed vial. Exactly 5 ml of HPLC grade water at room temperature are added, the vial is recapped and shaken another 30 minutes. After phase separation the aqueous phase was used for Gel Filtration Chromatography and injected via a 0.45 micron syringe filter.

It is apparent to those skilled in the art that different analytical methods may result in slightly different results. However, at least to the extent above methods are concerned, the results were found to be consistent within their specific and inherent limits of error.

### Blends

The (halogenated) copolymer products according to the invention may be blended either with each other or additionally or alternatively with at least one secondary rubber being different from the (halogenated) polymer product, which is preferably selected from the group consisting of natural rubber (NR), epoxidized natural rubber (ENR), polyisoprene rubber, poly(styrene-co-butadiene) rubber (SBR), chloroprene rubber (CR), polybutadiene rubber (BR), perfluoro(halogenated) copolymer (FFKM/FFPM), ethylene vinylacetate (EVA) rubber, ethylene acrylate rubber, polysulphide rubber (TR), poly(isoprene-co-butadiene) rubber (IBR), styrene-isoprene-butadiene rubber (SIBR), ethylene-propylene rubber (EPR), ethylene-propylene-diene M-class rubber (EPDM), polyphenylensulfide, nitrile-butadiene rubber (NBR), hydrogenated nitrile-butadiene rubber (HNBR), propylene oxide polymers, star-branched butyl rubber and halogenated star-branched butyl rubber, butyl rubbers which are not subject of the present invention i.e. having i.a. different levels of multivalent metal ions or purity grages, star-branched polyisobutylene rubber, star-branched brominated butyl (polyisobutylene/isoprene (halogenated) copolymer) rubber; poly(isobutylene-co-p-methylstyrene) and halogenated poly(isobutylene-co-p-methylstyrene), poly(isobutylene-co-isoprene-co-styrene), poly(isobutylene-co-isoprene-co-alpha-methylstyrene), halogenated poly(isobutylene-co-isoprene-co-a-methylstyrene).

One or more of the (halogenated) copolymer products or the blends with secondary rubbers described above may be further blended additionally or alternatively for example simultaneously or separately with at least one thermoplastic polymer, which is preferably selected from the group consisting of polyurethane (PU), polyacrylic esters (ACM, PMMA), thermoplastic polyester urethane (AU), thermoplastic polyether urethane (EU), perfluoroalkoxyalkane (PFA), polytetrafluoroethylene (PTFE), and polytetrafluoroethylene (PTFE).

One or more of the (halogenated) copolymer products or the blends with secondary rubbers and/or thermoplastic polymers described above may be compounded with one or more fillers. The fillers may be non-mineral fillers, mineral fillers or mixtures thereof. Non-mineral fillers are preferred in some embodiments and include, for example, carbon blacks, rubber gels and mixtures thereof. Suitable carbon blacks are preferably prepared by lamp black, furnace black or gas black processes. Carbon blacks preferably have BET specific surface areas of 20 to 200 m²/g. Some specific examples of carbon blacks are SAF, ISAF, HAF, FEF and GPF carbon blacks. Rubber gels are preferably those based on polybutadiene, butadiene/styrene (halogenated) copolymers, butadiene/acrylonitrile (halogenated) copolymers or polychloroprene.

Suitable mineral fillers comprise, for example, silica, silicates, clay, bentonite, vermiculite, nontronite, beidelite, volkonskoite, hectorite, saponite, laponite, sauconite, magadiite, kenyaite, ledikite, gypsum, alumina, talc, glass, metal oxides (e.g. titanium dioxide, zinc oxide, magnesium oxide, aluminum oxide), metal carbonates (e.g. magnesium carbonate, calcium carbonate, zinc carbonate), metal hydroxides (e.g. aluminum hydroxide, magnesium hydroxide) or mixtures thereof.

Dried amorphous silica particles suitable for use as mineral fillers may have a mean agglomerate particle size in the range of from 1 to 100 microns, or 10 to 50 microns, or 10 to 25 microns. In one embodiment, less than 10 percent by volume of the agglomerate particles may be below 5 microns. In one embodiment, less than 10 percent by volume of the agglomerate particles may be over 50 microns in size. Suitable amorphous dried silica may have, for example, a BET surface area, measured in accordance with DIN (Deutsche Industrie Norm) 66131, of between 50 and 450 square meters per gram. DBP absorption, as measured in accordance with DIN 53601, may be between 150 and 400 grams per 100 grams of silica. A drying loss, as measured according to DIN ISO 787/11, may be from 0 to 10 percent by weight.

Suitable silica fillers are commercially sold under the names HiSil™ 210, HiSil™ 233 and HiSil™ 243 available from PPG Industries Inc. Also suitable are Vulkasil™ S and Vulkasil™ N, commercially available from Bayer AG.

High aspect ratio fillers useful in the present invention may include clays, talcs, micas, etc. with an aspect ratio of at least 1:3. The fillers may include acircular or nonisometric materials with a platy or needle-like structure. The aspect ratio is defined as the ratio of mean diameter of a circle of the same area as the face of the plate to the mean thickness of the plate. The aspect ratio for needle and fiber shaped fillers is the ratio of length to diameter. The high aspect ratio fillers may have an aspect ratio of at least 1:5, or at least 1:7, or in a range of 1:7 to 1:200. High aspect ratio fillers may have, for example, a mean particle size in the range of from 0.001 to 100 microns, or 0.005 to 50 microns, or 0.01 to 10 microns. Suitable high aspect ratio fillers may have a BET surface area, measured in accordance with DIN (Deutsche Industrie Norm) 66131, of between 5 and 200 square meters per gram. The high aspect ratio filler may comprise a nanoclay, such as, for example, an organically modified nanoclay. Examples of nanoclays include natural powdered smectite clays (e.g. sodium or calcium montmorillonite) or synthetic clays (e.g. hydrotalcite or laponite). In one embodiment, the high aspect filler may include organically modified montmorillonite nanoclays. The clays may be modified by substitution of the transition metal for an onium ion, as is known in the art, to provide surfactant functionality to the clay that aids in the dispersion of the clay within the generally hydrophobic polymer environment. In one embodiment, onium ions are phosphorus based (e.g. phosphonium ions) or nitrogen based (e.g. ammonium ions) and contain functional groups having from 2 to 20 carbon atoms. The clays may be provided, for example, in nanometer scale particle sizes, such as, less than 25 μm by volume. The particle size may be in a range of from 1 to 50 μm, or 1 to 30 μm, or 2 to 20 μm. In addition to silica, the nanoclays may also contain some fraction of alumina. For example, the nanoclays may contain from 0.1 to 10 Wt.-% alumina, or 0.5 to 5 Wt.-% alumina, or 1 to 3 Wt.-% alumina. Examples of commercially available organically modified nanoclays as high aspect ratio mineral fillers include, for example, those sold under the trade name Cloisite® clays 10A, 20A, 6A, 15A, 30B, or 25A.

One or more of the (halogenated) copolymer products or the blends with secondary rubbers and/or thermoplastic polymers or the compounds described above are hereinafter collectively referred to as polymer products and may further contain other ingredients such as curing agents, reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc., which are known to the rubber industry. These ingredients are used in conventional amounts that depend, inter alia, on the intended use.

The polymer products may further contain a curing system which allows them to be cured.

The choice of curing system suitable for use is not particularly restricted and is within the purview of a person skilled in the art. In certain embodiments, the curing system may be sulphur-based, peroxide-based, resin-based or ultraviolet (UV) light-based. sulfur-based curing system may comprise: (i) at least one metal oxide which is optional, (ii) elemental sulfur and (iii) at least one sulfur-based accelerator. The use of metal oxides as a component in the sulphur curing system is well known in the art and preferred.

A suitable metal oxide is zinc oxide, which may be used in the amount of from about 1 to about 10 phr. In another embodiment, the zinc oxide may be used in an amount of from about 2 to about 5 phr.

Elemental sulfur, is typically used in amounts of from about 0.2 to about 2 phr.

Suitable sulfur-based accelerators may be used in amounts of from about 0.5 to about 3 phr.

Non-limiting examples of useful sulfur-based accelerators include thiuram sulfides (e.g. tetramethyl thiuram disulfide (TMTD)), thiocarbamates (e.g. zinc dimethyl dithiocarbamate (ZDMC), zinc dibutyl dithiocarbamate (ZDBC), zinc dibenzyldithiocarbamate (ZBEC) and thiazyl or benzothiazyl compounds (e.g. 4-morpholinyl-2-benzothizyl disulfide (Morfax), mercaptobenzothiazol (MBT) and mercaptobenzothiazyl disulfide (MBTS)). A sulphur based accelerator of particular note is mercaptobenzothiazyl disulfide.

Depending on the specific nature an in particular the level of unsaturation of the (halogenated) copolymers according to the invention peroxide based curing systems may also be suitable. A peroxide-based curing system may comprises a peroxide curing agent, for example, dicumyl peroxide, di-tert-butyl peroxide, benzoyl peroxide, 2,2′-bis(tert.-butylperoxy diisopropylbenzene (Vulcup® 40KE), benzoyl peroxide, 2,5-dimethyl-2,5-di(tert-butylperoxy)-hexyne-3, 2,5-dimethyl-2,5-di(benzoylperoxy)hexane, (2,5-bis(tert-butylperoxy)-2,5-dimethyl hexane and the like. One such peroxide curing agent comprises dicumyl peroxide and is commercially available under the name DiCup 40C. Peroxide curing agents may be used in an amount of about 0.2-7 phr, or about 1-6 phr, or about 4 phr. Peroxide curing co-agents may also be used. Suitable peroxide curing co-agents include, for example, triallyl isocyanurate (TAlC) commercially available under the name DIAK 7 from DuPont, N,N′-m-phenylene dimaleimide known as HVA-2 from DuPont or Dow), triallyl cyanurate (TAC) or liquid polybutadiene known as Ricon D 153 (supplied by Ricon Resins). Peroxide curing co-agents may be used in amounts equivalent to those of the peroxide curing agent, or less. The state of peroxide cured articles is enhanced with butyl polymers comprising increased levels of unsaturation, for example a multiolefin content of at least 0.5 mol-%.

The polymer products may also be cured by the resin cure system and, if required, an accelerator to activate the resin cure.

Suitable resins include but are not limited to phenolic resins, alkylphenolic resins, alkylated phenols, halogenated alkyl phenolic resins and mixtures thereof.

When used for curing butyl rubber, a halogen activator is occasionally used to effect the formation of crosslinks. Such activators include stannous chloride or halogen-containing polymers such as polychloroprene. The resin cure system additionally typically includes a metal oxide such as zinc oxide.

Halogenated resins in which some of the hydroxyl groups of the methylol group are replaced with, e.g., bromine, are more reactive. With such resins the use of additional halogen activator is not required.

Illustrative of the halogenated phenol aldehyde resins are those prepared by Schenectady Chemicals, Inc. and identified as resins SP 1055 and SP 1056. The SP 1055 resin has a methylol content of about 9 to about 12.5% and a bromine content of about 4%. whereas the SP 1056 resin has a methylol content of about 7.5 to about 11% and a bromine content of about 6%. Commercial forms of the nonhalogenated resins are available such as SP-1044 with a methylol content of about 7 to about 9.5% and SP-1045 with a methylol content of about 8 to about 11%.

The selection of the various components of the resin curing system and the required amounts are known to persons skilled in the art and depend upon the desired end use of the rubber compound. The resin cure as used in the vulcanization of (halogenated) copolymers comprising unsaturation, and in particular for butyl rubber is described in detail in “Rubber Technology” Third Edition, Maurice Morton, ed., 1987, pages 13-14, 23, as well as in the patent literature, see, e.g., U.S. Pat. Nos. 3,287,440 and 4,059,651.

Since the aforementioned sulfur-based curing system, resin cure systems and peroxide based curing systems are particularly useful in combination with the copolymers according to the invention, the invention also encompasses the use of such cure sulfur-based curing system, resin cure systems and peroxide based curing systems and their specific components as mentioned above singly and jointly for curing compounds comprising the copolymers according to the invention.

To the extent the polymer products disclosed above whether uncure or cured exhibit the levels of salts of multivalent metal ions, in particular the levels of stearates and palmitates of multivalent metal ions with respect to their contents of the (halogenated) copolymers according to the invention there are as such novel and consequently encompassed by the invention as well.

The invention further encompasses the use of the (halogenated) copolymer products to prepare the polymer products described above and a process for the preparation of the polymer products described above by blending or compounding the ingredients mentioned above.

Such ingredients may be compounded together using conventional compounding techniques. Suitable compounding techniques include, for example, mixing the ingredients together using, for example, an internal mixer (e.g. a Banbury mixer), a miniature internal mixer (e.g. a Haake or Brabender mixer) or a two roll mill mixer. An extruder also provides good mixing, and permits shorter mixing times. It is possible to carry out the mixing in two or more stages, and the mixing can be done in different apparatuses, for example one stage in an internal mixer and one stage in an extruder. For further information on compounding techniques, see Encyclopedia of Polymer Science and Engineering, Vol. 4, p. 66 et seq. (Compounding). Other techniques, as known to those of skill in the art, are further suitable for compounding.

It was surprisingly found that the (halogenated) copolymers according to the invention due to their low stearate concentration and low cyclic polymer levels allow much better curing, in particular when resin cured.

### Applications

The polymer products according to the invention may due to their unique purity as components of pharmaceutical containers, such as closures for parenteral (I.V.) vials, closures for injection vials, closures for vials containing freeze dried pharmaceutical products, closures for blood collection tubes or other diagnostic tubes, plungers and plunger tips for syringes, discs and gaskets, intravenous drug delivery components and like applications and additionally in medical devices, objects with food and drink contact, such as seals and gaskets in bottle caps, objects or components of objects used in cell and tissue culture, further as an elastomer in gum base in the production of chewing gum.

Generally, the polymer products according to the invention are highly useful in wide variety of applications. The low degree of permeability to gases, the unsaturation sites which may serve as crosslinking, curing or post polymerization modification site as well as their low degree of disturbing additives accounts for the largest uses of these rubbers.

Therefore, the invention also encompasses the use of the polymer products according to the invention for innerliners, bladders, tubes, air cushions, pneumatic springs, air bellows, accumulator bags, hoses, conveyor belts and pharmaceutical closures. The invention further encompasses the aforementioned products comprising the polymer products according to the invention whether cured or/uncured.

The polymer products further exhibit high damping and have uniquely broad damping and shock absorption ranges in both temperature and frequency.

Therefore, the invention also encompasses the use of the polymer products according to the invention in automobile suspension bumpers, auto exhaust hangers, body mounts and shoe soles.

The polymer products of the instant invention are also useful in tire sidewalls and tread compounds. In sidewalls, the polymer characteristics impart good ozone resistance, crack cut growth, and appearance.

The polymer products may be shaped into a desired article prior to curing. Articles comprising the cured polymer products include, for example, belts, hoses, shoe soles, gaskets, o-rings, wires/cables, membranes, rollers, bladders (e.g. curing bladders), inner liners of tires, tire treads, shock absorbers, machinery mountings, balloons, balls, golf balls, protective clothing, medical tubing, storage tank linings, electrical insulation, bearings, pharmaceutical stoppers, adhesives, a container, such as a bottle, tote, storage tank, etc.; a container closure or lid; a seal or sealant, such as a gasket or caulking; a material handling apparatus, such as an auger or conveyor belt; power belts, a cooling tower; a metal working apparatus, or any apparatus in contact with metal working fluids; an engine component, such as fuel lines, fuel filters, fuel storage tanks, gaskets, seals, etc.; a membrane, for fluid filtration or tank sealing.

Additional examples where the polymer products may be used in articles or coatings include, but are not limited to, the following: appliances, baby products, bathroom fixtures, bathroom safety, flooring, food storage, garden, kitchen fixtures, kitchen products, office products, pet products, sealants and grouts, spas, water filtration and storage, equipment, food preparation surfaces and equipments, shopping carts, surface applications, storage containers, footwear, protective wear, sporting gear, carts, dental equipment, door knobs, clothing, telephones, toys, catheterized fluids in hospitals, surfaces of vessels and pipes, coatings, food processing, biomedical devices, filters, additives, computers, ship hulls, shower walls, tubing to minimize the problems of biofouling, pacemakers, implants, wound dressing, medical textiles, ice machines, water coolers, fruit juice dispensers, soft drink machines, piping, storage vessels, metering systems, valves, fittings, attachments, filter housings, linings, and barrier coatings.

1. A process for the preparation of a pure copolymer, the process comprising:
A) filtering a first organic medium comprising:
i) at least one copolymer comprising a first fraction of cyclic copolymers having a molecular weight of 2000 g/mol or less, wherein the at least one copolymer is optionally hydrogenated, and
ii) an organic diluent
through a semipermeable ultrafiltration membrane to produce
a retentate and an organic diluent, wherein the retentate comprises at least one copolymer comprising a second fraction of the cyclic copolymers having a molecular weight of 2000 g/mol or less, wherein the second fraction is lower than the first fraction, and
a permeate and an organic diluent, wherein the permeate comprises an additional fraction of cyclic copolymers having a molecular weight of 2000 g/mol or less and an organic diluent, and
B) contacting a second organic medium comprising:
i) the copolymer of, or obtained from the retentate, and
ii) an organic diluent
with an aqueous medium comprising at least one LCST compound having a cloud point of 0 to 100° C., and
removing at least partially the organic diluent to obtain the pure copolymer.

2. The process according to claim 1, wherein the aqueous medium further contains non-LCST compounds, whereby the non-LCST compounds are
selected from the group consisting of ionic or non-ionic surfactants, emulsifiers, and antiagglomerants
salts of (mono- or multivalent) metal ions
carboxylic acid salts of multivalent metal ions
stearates or palmitates of mono- or multivalent metal ions, or
calcium and zinc stearates or palmitates.

3. The process according to claim 2, wherein the aqueous medium comprises:
20,000 ppm or less of the non-LCST compounds; and
500 ppm or less of dispersants, emulsifiers or anti-agglomerants other than the LCST compounds.

4. The process according to claim 1, wherein the aqueous medium comprises:
1,000 ppm or less of the non-LCST compounds; and
no dispersants, emulsifiers or anti-agglomerants other than the LCST compounds.

5. The process according to claim 1, wherein:
the amount of LST compound(s) present in the aqueous medium employed in step A) is 1 to 20,000 ppm with respect to the amount of copolymer in the second organic medium; and
the at least one LCST compound is selected from the group consisting of:
poly(N-isopropylacrylamide), poly(N-isopropylacrylamide-co-N,N-dimethylacrylamide, poly(N-isopropylacrylamide)-alt-2-hydroxyethylmethacrylate, poly(N-vinylcaprolactam), poly(N,N-diethylacrylamide), poly[2-(dimethylamino)ethyl methacrylate], poly(2-oxazoline) glycopolymers, Poly(3-ethyl-N-vinyl-2-pyrrolidone), hydroxylbutyl chitosan, polyoxyethylene (20) sorbitan monostearate, polyoxyethylene (20) sorbitan monolaurate, polyoxyethylene (20) sorbitan monooleate, methyl cellulose, hydroxypropyl cellulose, hydroxyethyl methylcellulose, hydroxypropyl methylcellulose, poly(ethylene glycol) methacrylates with 2 to 6 ethylene glycol units, polyethyleneglycol-co-polypropylene glycols, compounds of formula (I)
HO—[—CH₂—CH₂—O]ₓ—[—CH(CH₃)—CH₂—O]_{y}—[—CH₂—CH₂—O]_{z}—H (I)
with y=3 to 10 and x and z=1 to 8, whereby y+x+z is from 5 to 18,
polyethyleneglycol-co-polypropylene glycol, ethoxylated iso-C₁₃H₂₇-alcohols, polyethylene glycol with 4 to 50, polypropylene glycol with 4 to 30 propyleneglycol units, polyethylene glycol monomethyl, dimethyl, monoethyl and diethyl ether with 4 to 50 ethyleneglycol units, polypropylene glycol monomethyl, dimethyl, monoethyl and diethyl ether with 4 to 50 propyleneglycol units.

6. (canceled)

7. The process according to claim 1, wherein:
the amount of LCST compound(s) present in the aqueous medium employed in step A) is of from 1 to 5,000 ppm, preferably 3 to 1,000 ppm, more preferably 5 to 500 ppm and even more preferably 5 to 100 ppm with respect to the amount of copolymer in the second organic medium; and
the LCST compounds exhibit a molecular weight of at least 1,500 g/mol, preferably at least 2,500 g/mol and more preferably at least 4,000 g/mol.

8. (canceled)

9. An optionally halogenated copolymer obtained according to the process according to claim 1.

10. A copolymer product comprising a copolymer content of 98.5 wt.-% or more, preferably 99.8 wt.-% or more, more preferably 99.0 wt.-% or more, even more preferably 99.2 wt.-% or more, yet even more preferably 99.4 wt.-% or more, and in another embodiment 99.5 wt.-% or more, preferably 99.7 wt.-% or more, having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the copolymer, and wherein the copolymer is optionally hydrogenated.

11. The copolymer product according to claim 10, comprising 550 ppm or less, preferably 400 ppm or less, more preferably 300 ppm or less, even more preferably 250 ppm or less, and yet even more preferably 150 ppm or less, and in another yet even more preferred embodiment 100 ppm or less of salts of mono- or multivalent metal ions calculated on their metal content.

12. The copolymer product according to claim 10, comprising 5000 ppm or less, preferably 2.000 ppm or less, more preferably 1.000 ppm or less, even more preferably 500 ppm or less and yet even more preferably 100 ppm or less and in another yet even more preferred embodiment 50 ppm or less, preferably 50 ppm or less more preferably 10 ppm or less and yet even more preferably no non-LCST compounds whereby the non-LCST compounds are
selected from the group consisting of ionic or non-ionic surfactants, emulsifiers, and antiagglomerants,
salts of (mono- or multivalent) metal ions,
carboxylic acid salts of multivalent metal ions,
stearates or palmitates of mono- or multivalent metal ions, or
calcium and zinc stearates or palmitates.

13. The copolymer product according to claim 10, comprising
I) 96.0 wt.-% or more, preferably 97.0 wt.-% or more, more preferably 98.0 wt-% or more, even more preferably 99.0 wt.-% or more, yet even more preferably 99.2 wt.-% or more, and in another embodiment 99.5 wt.-% or more of the copolymer having a fraction of cyclic copolymers having a molecular weight of 2000 g/mol or less in the range of from 20 to 2,000, preferably of from 30 to 1,000 ppm, more preferably from 50 to 850 ppm and more preferably of from 50 to 500 ppm of the total weight of the copolymer,
II) 0 to 3.0 wt.-%, preferably 0 to 2.5 wt.-%, more preferably 0 to 1.0 wt.-% and more preferably 0 to 0.40 wt.-% of salts of mono- or multivalent metal ions, preferably stearates and palmitates of multivalent metal ions, and
III) 1 ppm to 5,000 ppm, preferably from 1 ppm to 2,000 ppm, and in a more preferred embodiment from 5 to 1,000 ppm, or from 5 to 500 ppm of at least one LCST compound.

14. The copolymer product according to claim 10, comprising
I) 100 parts by weight of the copolymer having a fraction of cyclic copolymers having a molecular weight of 2000 g/mol or less in the range of from 20 to 2,000, preferably of from 30 to 1,000 ppm, more preferably from 50 to 850 ppm, and more preferably of from 50 to 500 ppm of the total weight of the copolymer,
II) 0.0001 to 0.5, preferably 0.0001 to 0.2, more preferably 0.0005 to 0.1, even more preferably 0.0005 to 0.05 parts by weight of a least one LCST compound,
III) no or from 0.0001 to 3.0, preferably no or from 0.0001 to 2.0, more preferably no or from 0.0001 to 1.0, even more preferably no or from 0.0001 to 0.5, yet even more preferably no or from 0.0001 to 0.3, and most preferably no or from 0.0001 to 0.2 parts by weight of salts of mono- or multivalent metal ions, preferably stearates and palmitates of mono- or multivalent metal ions, preferably comprising calcium stearate, calcium palmitate, zinc stearate or zinc palmitate,
IV) no or from 0.005 to 0.3, preferably 0.05 to 0.1, more preferably from 0.008 to 0.05 and yet more preferably from 0.03 to 0.07 parts by weight of antioxidants, and
V) from 0.005 to 1.5, preferably 0.05 to 1.0, more preferably 0.005 to 0.5, even more preferably from 0.01 to 0.3, and yet even more preferably from 0.05 to 0.2 parts by weight of volatiles having a boiling point at standard pressure of 200° C. or less,
whereby preferably the aforementioned components I) to V) add up to 100.00501 to 105.300000 parts by weight, preferably 100.00501 to 104.100000 parts by weight, more preferably from 100.01 to 103.00 parts by weight, even more preferably from 100.10 to 101.50 parts by weight, yet even more preferably from 100.10 to 100.80 parts by weight and together represent 99.50 to 100.00 wt.-% or, in another embodiment, 99.80 to 100.00 wt.-%, preferably 99.90 to 100.00 wt.-%, more preferably 99.95 to 100.00 wt.-%, and yet even more preferably 99.97 to 100.00 wt.-%, of the total weight of the copolymer product.

15. The copolymer product according to claim 14, further comprising
VI) from 0.05 to 2.5, preferably from 0.20 to 1.50, more preferably from 0.50 to 1.50 parts by weight and even more preferably 0.75 to 1.50 parts by weight of stabilizers, preferably epoxidized compounds, preferably epoxidized unsaturated oils such as epoxidized linseed oil or epoxidized soybean oil, whereby the latter is preferred and
whereby preferably the aforementioned components I) to VI) add up to 100.05501 to 107.800000 parts by weight, preferably 100.05501 to 106.600000 parts by weight, preferably from 100.21 to 104.50 parts by weight, more preferably from 100.60 to 103.00 parts by weight, even more preferably from 100.85 to 102.30 parts by weight and together represent 99.50 to 100.00 wt.-% or, in another embodiment, 99.80 to 100.00 wt.-%, preferably 99.90 to 100.00 wt.-%, more preferably 99.95 to 100.00 wt.-% and yet even more preferably 99.97 to 100.00 wt.-% of the total weight of the copolymer product.

16. The copolymer product according to claim 10, comprising 97.5 wt.-% or more, preferably 98.0 wt.-% or more, more preferably, 98.2 wt.-% or more even more preferably 98.4 wt.-% or more, yet even more preferably 98.5 wt.-% or more, and in another embodiment 99.5 wt.-% or more of the copolymer having a fraction of cyclic copolymers having a molecular weight of 2000 g/mol or less in the range of from 20 to 2,000, preferably of from 30 to 1,000 ppm, more preferably from 50 to 850 ppm, and more preferably of from 50 to 500 ppm of the total weight of the copolymer and having an ash content measured according to ASTM D5667 of 0.25 wt.-% or less, preferably 0.15 wt.-% or less, more preferably 0.10 wt.-% or tees and even more preferably 0.05 wt.-% or less.

17. The copolymer product according to claim 16, comprising 1 ppm to 5,000 ppm, preferably from 1 ppm to 2,000 ppm, and in a more preferred embodiment from 5 to 1,000 ppm, or from 5 to 500 ppm of a least one LCST compound.

18. The copolymer product according to claim 10 wherein the copolymer comprises repeating units derived from at least one isoolefin and at least one multiolefin.

19. The copolymer products according to claim 18, whereby the copolymer products are halogenated, and the copolymer comprises repeating units derived from at least one isoolefin and at least one multiolefin whereby the repeating units derived from the multiolefin are at least partially halogenated.

20. The copolymer products according to claim 10 wherein:
the (halogenated) copolymer consists of repeating units derived from isobutylene and isoprene whereby the repeating units derived from isoprene in case of the halogenated copolymers are at least partially halogenated;
the (halogenated) copolymers have a multiolefin content of 0.1 mol-% or more, preferably of from 0.1 mol-% to 15 mol-%, in another embodiment 0.5 mol-% or more, preferably of from 0.5 mol-% to 10 mol-%, in another embodiment 0.7 mol-% or more, preferably of from 0.7 to 8.5 mol-% in particular of from 0.8 to 1.5 or from 1.5 to 2.5 mol-% or of from 2.5 to 4.5 mol-% or from 4.5 to 8.5 mol-%, particularly where isobutene and isoprene are employed; and
the (halogenated) copolymers, has a weight average molecular weight in the range of from 10 to 2,000 kg/mol, preferably in the range of from 20 to 1,000 kg/mol, more preferably in the range of from 50 to 1,000 kg/mol, even more preferably in the range of from 200 to 800 kg/mol, yet more preferably in the range of from 375 to 550 kg/mol, and most preferably in the range of from 400 to 500 kg/mol.

21. (canceled)

22. (canceled)

23. Blends or compounds obtained by blending or compounding the copolymer product according to claim 10.

24. The blends or compounds according to claim 23, whereby the blends comprise a ratio of copolymer to carboxylic acid salts of mono- and multivalent metal ions of at least 250:1, preferably at least 500:1, more preferably at least 1000:1, any yet even more preferably at least 2000:1.

25. (canceled)
